(19) United States
(12) Patent Application Publication
(10) Pub. No.: US 2024/0396027 A1
(43) Pub. Date: Nov. 28, 2024

(54) NEGATIVE ELECTRODE PLATE AND LITHIUM-ION BATTERY

(71) Applicant: ZHUHAI COSMX BATTERY CO., LTD., Zhuhai (CN)

(72) Inventors: Hongsheng FAN, Zhuhai (CN); Chunyang LIU, Zhuhai (CN); Jiachen XUE, Zhuhai (CN); Suli LI, Zhuhai (CN); Junyi LI, Zhuhai (CN)

(73) Assignee: ZHUHAI COSMX BATTERY CO., LTD., Zhuhai (CN)

(21) Appl. No.: 18/797,150

(22) Filed: Aug. 7, 2024

Related U.S. Application Data
(63) Continuation of application No. PCT/CN2023/075485, filed on Feb. 10, 2023.

(30) Foreign Application Priority Data
Feb. 10, 2022 (CN) 202210125565.7
Feb. 10, 2022 (CN) 202210125567.6
Feb. 10, 2022 (CN) 202210126327.8

(51) Int. Cl. H01M 4/36; H01M 4/02; H01M 4/48; H01M 4/587; H01M 10/0525

(52) U.S. Cl. CPC H01M 4/366; H01M 4/48; H01M 4/587; H01M 10/0525; H01M 2004/021; H01M 2004/027

(57) ABSTRACT

Disclosed are a negative electrode plate and a lithium-ion battery including the negative electrode plate. The negative electrode plate includes a negative electrode current collector and a negative electrode active material layer, the negative electrode active material layer is disposed on at least one surface of the negative electrode current collector, the negative electrode active material layer includes silicon-based material particles, and the silicon-based material particles include silicon oxide and/or silicon carbide; and the silicon-based material particles meet the following relationship: Dᵢ≤35 μm (I), dᵢ≤25 μm (II), 0.45≤(ΣEⱼ²)/(ΣDᵢ²)≤0.75 (III), and (ΣFₖ²)/(ΣDᵢ²)≥0.37 (IV), and a mixing amount of the silicon-based material particles meets the following relationship: 0.05≤(ΣFₖ²)/S≤0.47 (V). The lithium-ion battery disclosed in the present disclosure has characteristics of high energy density and a long cycle life.

### CROSS-REFERENCE TO RELATED APPLICATIONS

The present disclosure is a continuation application of International Application No. PCT/CN2023/075485, filed on Feb. 10, 2023, which claims priorities to Chinese Patent Application No. CN202210125565.7, filed on Feb. 10, 2022, to Chinese Patent Application No. CN202210125567.6, filed on Feb. 10, 2022, and to Chinese Patent Application No. CN202210126327.8, filed on Feb. 10, 2022. All of the aforementioned applications are incorporated herein by reference in their entireties.

### TECHNICAL FIELD

The present disclosure pertains to the field of energy storage, and relates to a negative electrode plate and a lithium-ion battery that includes the negative electrode plate.

### BACKGROUND

In recent years, requirements of consumers on endurance capabilities of electronic products and electric vehicles have been increasing, and consequently, higher requirements are also put forward on energy density of lithium-ion batteries as energy carriers.

Silicon oxide particles have three advantages over graphite. First, under the same capacity and surface density conditions, a thickness of a negative electrode plate containing silicon oxide particles is smaller, and therefore, the negative electrode plate has a shorter liquid-phase lithium-ion diffusion path. Second, silicon oxide particles have a relatively amorphous structure and have an alloy-type lithium storage mode, and therefore, have more lithium intercalation channels. Third, silicon oxide particles have a lithium intercalation potential higher than that of graphite, and it is less likely to cause lithium deposition during large rate charging. At room temperature, a reversible capacity of silicon is about ten times that of graphite, and therefore, silicon oxide particles with silicon as an active component have great application prospects in batteries with high energy density.

Adding a specific proportion of silicon oxide particles to a graphite negative electrode system can effectively increase a gram capacity of a negative electrode, and then increase energy density of a battery. However, introduction of silicon oxide particles may lead to a decrease in cycling performance of the negative electrode. In addition, according to a porous electrode theory, uniformity of lithium intercalation of active materials in a negative electrode plate is related to active materials used in the negative electrode plate and an overall structure of the negative electrode plate. Polarization potentials of the negative electrode plate are unevenly distributed, and large rate charging may aggravate such unevenness. In this way, a constant-current charging time is reduced. As a result, how to construct a lithium-ion battery having characteristics of high energy density and a long cycle life has become a difficult problem that needs to be solved urgently in the field of negative electrode material development and battery design.

Therefore, it is urgent to develop a lithium-ion battery having characteristics of both high energy density and a long cycle life.

### SUMMARY

To improve the foregoing technical problems, the present disclosure provides a negative electrode plate with a long cycle life and a lithium-ion battery including the negative electrode plate.

To achieve the foregoing objectives, the present disclosure is implemented by using the following technical solutions.

A negative electrode plate is provided. The negative electrode plate includes a negative electrode current collector and a negative electrode active material layer, the negative electrode active material layer is disposed on at least one surface of the negative electrode current collector, the negative electrode active material layer includes silicon-based material particles, and the silicon-based material particles include silicon oxide and/or silicon carbide; and
the silicon-based material particles meet the following relationship:

$${D}_{i} \leq 35 µm , \qquad ( I )$$

$${d}_{i} \leq 25 µm , \qquad ( II )$$

$$0.45 \leq ( \sum {E}_{j}^{2} ) / ( \sum {D}_{i}^{2} ) \leq 0 \text{.75} , \qquad ( III )$$

$$and$$

$$( \sum {F}_{k}^{2} ) / ( \sum {D}_{i}^{2} ) \geq 0 \text{.37} , \qquad ( IV )$$

where
Σ represents performing summation on data, Dᵢ represents a diameter of a circumscribed circle of any silicon-based material particle, in a unit of μm, dᵢ represents a diameter of an inscribed circle of any silicon-based material particle, in a unit of μm, Eⱼ represents a diameter of a circumscribed circle of a silicon-based material particle having Dᵢ≥9 μm, in a unit of μm, Fₖ represents a diameter of a circumscribed circle of a silicon-based material particle having dᵢ≥4 μm, in a unit of μm, and i, j, and k represent numbers of silicon-based material particles.

In an example, in the negative electrode plate, a mixing amount of the silicon-based material particles meets the following relationship:

$$0.05 \leq ( \sum {F}_{k}^{2} ) / S \leq 0.47 , \qquad ( V )$$

Σ represents performing summation on data, Fₖ represents a diameter of a circumscribed circle of a silicon-based material particle having dᵢ≥4 μm, in a unit of μm, k represents a number of a silicon-based material particle, and S represents a cross-sectional area of a negative electrode active material layer in an observation region, in a unit of μm².

The present disclosure further provides silicon-based material particles for the foregoing negative electrode plate. The silicon-based material particles include at least the following characteristics:

$${D}_{v} max \leq 35 , \qquad ( VI )$$

$$9. \leq {D}_{v} 50 \leq 13. , \qquad ( VII )$$

$$and$$

$$B E T \leq 1.2 , \qquad ( VIII )$$

where
Dᵥmax represents a maximum particle size of the silicon-based material particles, in a unit of μm;
Dᵥ50 represents a median particle size of the silicon-based material particles, in a unit of μm; and
BET represents a specific surface area of the silicon-based material particles, in a unit of m²/g.

The present disclosure further provides a lithium-ion battery. The lithium-ion battery includes the foregoing negative electrode plate.

In an example, after one to five charge-discharge cycles are performed for the lithium-ion battery, irreversible expansion occurs in the negative electrode plate (in other words, the negative electrode plate is thickened), and in this case, the negative electrode plate meets the following relationship:

$${D}_{i}^{′} \leq 44 µm , \qquad ( IX )$$

$${d}_{i}^{′} \leq 32 µm , \qquad ( X )$$

$$0.45 \leq ( \sum {E}_{j}^{′2} ) / ( \sum {D}_{i}^{′2} ) \leq 0 \text{.75} , \qquad ( XI )$$

$$( \sum {F}_{k}^{′2} ) / ( \sum {D}_{i}^{′2} ) \geq 0 \text{.37} , \qquad ( XII )$$

$$0.06 \leq ( \sum {F}_{k}^{′2} ) / {S}^{′} \leq 0.53 , \qquad ( XIII )$$

$$and$$

$$39 µm \leq {L}^{′} \leq 130 µm , \qquad ( XIV )$$

where
Σ represents performing summation on data, Dᵢ′ represents a diameter of a circumscribed circle of any silicon-based material particle, in a unit of μm, dᵢ′ represents a diameter of an inscribed circle of any silicon-based material particle, in a unit of μm, Eⱼ′ represents a diameter of a circumscribed circle of a silicon-based material particle having Dᵢ′≥11.2 μm, in a unit of μm, Fₖ′ represents a diameter of a circumscribed circle of a silicon-based material particle having dᵢ′≥5.0 μm, in a unit of μm, i, j, and k represent numbers of silicon-based material particles, S′ represents a cross-sectional area of the negative electrode plate in an observation region, in a unit of μm², and L′ represents a thickness of a negative electrode active material layer, in a unit of μm.

Beneficial effects of the present disclosure are as follows:

During initial lithium intercalation of silicon-based material particles, inert silicate components may be generated, and the inert silicate components act as a buffer against expansion during cycling. Therefore, under the same size conditions, silicon-based material particles have higher cycling stability than pure silicon particles. Nevertheless, in the research of constructing lithium-ion batteries with high energy density, it is found that even if a negative electrode plate containing silicon-based material particles is used, ideal cycling performance cannot be achieved. Further analysis reveals that the foregoing performance deficiencies are due to deficiencies in material selection and design of a hybrid negative electrode plate. In order to prevent excessive concentration of expansion stress during the cycling, a current common idea is to control a maximum particle size Dᵥmax of the silicon-based material particles to be at about 13 μm, which is less than or equal to a median particle size Dᵥ50 of graphite particles. This is conducive to uniform filling of silicon-based material particles between graphite particles, thereby reducing local stress and strain. However, when the idea is used, the silicon-based material particles have a particle size significantly less than that of the graphite particles, and therefore, has a larger specific surface area. For example, when the maximum particle size Dᵥmax of the silicon-based material particles is 13 μm, and Dᵥ50 is 5 μm, a specific surface area is about 3 m²/g; and when the maximum particle size Dᵥmax of the graphite particles is 35 μm, and Dᵥ50 is 15 μm, a specific surface area is about 1 m²/g. Because a volume of silicon-based material particles changes greatly during a lithium intercalation and deintercalation cycle, a surface SEI film may be continuously damaged and repaired, and a large specific surface area often brings more side reactions, a lithium-ion battery degrades faster. Therefore, on the premise of ensuring that local strain does not cause deformation of an electrode plate, increasing the particle size of silicon-based material particles as much as possible can help improve cycling performance. In addition, among all three-dimensional geometric solids, a sphere has the smallest specific surface area, while silicon-based material particles are usually formed by bulk crushing, including various irregular shapes such as rods, flakes, and polyhedrons. This feature leads to a larger specific surface area of the silicon-based material particles. Therefore, controlling a shape of the silicon-based material particles is also an important idea for adjusting the specific surface area and cycling performance.

In view of this, the present disclosure provides a negative electrode plate with a long cycle life and a lithium-ion battery that is based on the negative electrode plate. The lithium-ion battery has a characteristic of high energy density and has an advantage of a long cycle life under charging conditions at 0.1 C to 1.0 C. Further, the lithium-ion battery that is based on the negative electrode plate has good fast charging performance.

### BRIEF DESCRIPTION OF THE DRAWINGS

FIG. 1 is a schematic diagram of a circumscribed circle and an inscribed circle of a silicon-based material particle according to the present disclosure.

FIG. 2 shows a volume-based particle size distribution curve of silicon-based material particles in Example 1.

FIG. 3 is a SEM image (taken in a secondary electron mode) of the silicon-based material particles in Example 1.

FIG. 4 shows a SEM cross-sectional image (taken in a backscattered electron mode) of a negative electrode plate in Example 11, where circumscribed circles of silicon-based material particles are marked with circular dotted lines in the figure.

FIG. 5 shows a SEM cross-sectional image (taken in a backscattered electron mode) of a negative electrode plate in Example 11, where inscribed circles of some of the silicon-based material particles are marked with circular dotted lines in the figure.

FIG. 6 is a schematic cross-sectional diagram of an example of a negative electrode plate having an active material layer A that contains silicon-based material particles.

FIG. 7 is a schematic cross-sectional diagram of an example of a negative electrode plate having an active material layer A that does not contain silicon-based material particles.

### DETAILED DESCRIPTION OF THE EMBODIMENTS

### [Negative Electrode Plate and Preparation Thereof]

As described above, the present disclosure provides a negative electrode plate. The negative electrode plate includes a negative electrode current collector and a negative electrode active material layer, the negative electrode active material layer is disposed on at least one surface of the negative electrode current collector, the negative electrode active material layer includes silicon-based material particles, and the silicon-based material particles include silicon oxide and/or silicon carbide.

The silicon-based material particles meet the following relationship:

$${D}_{i} \leq 35 µm , \qquad ( I )$$

$${d}_{i} \leq 25 µm , \qquad ( II )$$

$$0.45 \leq ( \sum {E}_{j}^{2} ) / ( \sum {D}_{i}^{2} ) \leq 0 \text{.75} , \qquad ( III )$$

$$and$$

$$( \sum {F}_{k}^{2} ) / ( \sum {D}_{i}^{2} ) \geq 0 \text{.37} , \qquad ( IV )$$

where
Σ represents performing summation on data, Dᵢ represents a diameter of a circumscribed circle of any silicon-based material particle, in a unit of μm, dᵢ represents a diameter of an inscribed circle of any silicon-based material particle, in a unit of μm, Eⱼ represents a diameter of a circumscribed circle of a silicon-based material particle having Dᵢ≥9 μm, in a unit of μm, Fₖ represents a diameter of a circumscribed circle of a silicon-based material particle having dᵢ≥4 μm, in a unit of μm, and i, j, and k represent numbers of silicon-based material particles.

In the present disclosure, values of the parameters in Formula (I), Formula (II), Formula (III), and Formula (IV) are measured based on a cross-sectional image of a negative electrode plate. The cross-sectional image of the negative electrode plate can be obtained by cutting the negative electrode plate perpendicularly to a surface of the negative electrode plate by using an ion milling device and observing a cross section by using a scanning electron microscope (SEM) and energy-dispersive X-ray spectroscopy (EDS). A length of the negative electrode plate in an observation region is greater than or equal to 150 μm.

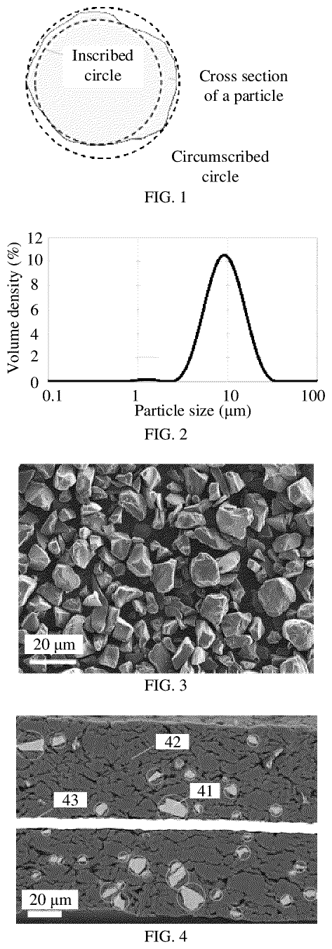

In the present disclosure, the circumscribed circle is a circle with the smallest diameter that can completely contain the silicon-based material particle. The inscribed circle is a circle with the largest diameter that can be completely contained by the silicon-based material particle. A schematic diagram of the circumscribed circle and the inscribed circle is shown in FIG. 1.

The present disclosure defines a particle size of a silicon-based material particle in the negative electrode plate through Formula (I) and Formula (II). When the foregoing conditions are met, the particle size of the silicon-based material particle is moderate, and a volume change of the silicon-based material particle during the cycle may not cause obvious deformation of the electrode plate. When there are silicon-based material particles with Dᵢ>35 μm or dᵢ>25 μm, an absolute value of a volume change of these particles during the cycle is large. This may cause excessive stress on local regions and a risk of bulging of the active material layer, leads to poor electrical contact between the active material layer and the current collector, and further accelerates cycling capacity fading of a battery.

The present disclosure defines not only particle size distribution of silicon-based material particles but also shapes of silicon-based material particles through Formula (III) and Formula (IV). Any cross-section of a sphere is a circle, and diameters of an inscribed circle and a circumscribed circle of the cross-section are equal. For an irregular geometric solid, the closer diameters of an inscribed circle and a circumscribed circle of a cross-sectional shape of the irregular geometric solid are to each other, the closer the shape of irregular geometric solid is to a circle. For example, when a diameter of a circumscribed circle is 1, a diameter of an inscribed circle of an equilateral triangle is 0.5, a diameter of an inscribed circle of a square is 0.71, a diameter of an inscribed circle of a regular hexagon is 0.87, and a diameter of an inscribed circle of a circle is 1. In view of this, it is found that when a size of a circumscribed circle of a cross-sectional shape of a silicon-based material particle is constant, a diameter of an inscribed circle of the cross-sectional shape needs to be large enough. In this case, an overall shape of a silicon oxide particle is closer to a sphere, thereby effectively reducing side reactions occurring on a surface of the silicon-based material particle. When Formula (III) and Formula (IV) are met, the electrode plate contains an appropriate proportion of silicon-based material particles having Dᵢ≥9 μm and a sufficient proportion of silicon-based material particles having dᵢ≥4 μm, and in this case, a specific surface area of the silicon-based material particles is less than or equal to 1.2 m²/g (a specific surface area of conventional silicon oxide is generally greater than 1.2 m²/g), leading to a small quantity of side reactions. When (ΣEⱼ²)/(ΣDᵢ²)<0.45, an overall particle size of the silicon-based material particles is small, and the specific surface area is large, leading to a large quantity of surface side reactions. When (ΣEⱼ²)/(ΣDᵢ²)>0.75, the overall particle size of the silicon-based material particles is too large, which can easily aggravate uneven stress distribution inside the electrode plate and then cause the electrode plate to deform. This leads to the poor electrical contact between the active material layer and the current collector, and further accelerates the cycling capacity fading of a battery. When (ΣFₖ²)/(ΣDᵢ²)<0.37, the overall shape of the silicon-based material particles deviates too far from a spherical shape, for example, there are a large quantity of rod-shaped or flake-shaped particles. In this case, the specific surface area of the silicon-based material particles is generally greater than 1.2 m²/g, leading to a large quantity of side reactions.

According to a specific implementation, in the negative electrode plate, a mixing amount of the silicon-based material particles meets the following relationship:

$$0.05 \leq ( \sum {F}_{k}^{2} ) / S \leq 0 \text{.47} , \qquad ( V )$$

Σ represents performing summation on data, Fₖ represents a diameter of a circumscribed circle of a silicon-based material particle having dᵢ≥4 μm, in a unit of μm, k represents a number of a silicon-based material particle, and S represents a cross-sectional area of a negative electrode active material layer in an observation region of a SEM image, in a unit of μm².

When (ΣFₖ²)/S<0.05, a content of the silicon-based material particles is too low to ensure that the lithium-ion battery has high energy density; and when (ΣFₖ²)/S>0.47, the content of silicon-based material particles is too high, and regions of particle aggregation are likely to appear, aggravating local expansion, leading to poor electrical contact of active materials, and causing fast capacity fading of the battery.

In an example, in the negative electrode plate, a specific surface area of the silicon-based material particles is less than or equal to 1.2 m²/g (for example, 1.2 m²/g, 1.1 m²/g, 1 m²/gm 0.9 m²/g, 0.7 m²/g, 0.5 m²/g, 0.3 m²/g, or 0.1 m²/g).

In an example, in the negative electrode active material layer, a mass concentration of the silicon-based material particles ranges from 5 wt % to 25 wt % (for example, 5 wt %, 10 wt %, 15 wt %, 20 wt %, or 25 wt %).

The negative electrode active material layer may contain the silicon-based material particles in at least a partial region. The “mass concentration of the silicon-based material particles” refers to a mass proportion of the silicon-based material particles in a negative electrode active material layer region containing the silicon-based material particles using only a weight of the negative electrode active material layer region containing the silicon-based material particles as a reference.

It is found through research that when the mass proportion of the silicon-based material particles ranges from 5 wt % to 25 wt %, the silicon-based material particles may be uniformly dispersed between graphite particles, and local stress is small.

According to a specific implementation, in the negative electrode plate, a thickness L of the negative electrode active material layer meets 30 μm≤L≤100 μm (for example, 30 μm, 40 μm, 50 μm, 60 μm, 70 μm, 80 μm, 90 μm, or 100 μm). When the thickness of the negative electrode active material layer is within this thickness range, coating uniformity and overall kinetics of the electrode plate of the battery can be ensured. When L<30 μm, a coating is too thin, and coating scraping and other phenomena are prone to occur, and uniformity of the electrode plate cannot be ensured; and when L>100 μm, the electrode plate is too thick, and a resulting polarization effect is severe, which may easily lead to lithium deposition on the electrode plate and cause fast cycling capacity fading of the battery.

The silicon-based material particles may include silicon oxide and/or silicon carbide.

In an example, the silicon-based material particles are silicon carbide particles.

In an example, the silicon-based material particles are silicon oxide particles.

According to a specific implementation, the silicon oxide particles contain an element Si and an element O, and a molar ratio x (mol/mol) of the element O to the element Si meets 0.7≤x≤1.4. For example, the molar ratio is 0.7, 0.8, 0.9, 1.0, 1.1, 1.2, 1.3, 1.4, or a point value in a range formed by any two of the foregoing values. When this relationship is met, the silicon oxide particles have a higher gram capacity and a stable structure; when x<0.7, less inert silicate matrix is generated after the silicon oxide particles are intercalated with lithium, and cycling structural stability is poor; and when x>1.4, a content of the oxygen element in the silicon oxide particles is too high, irreversible reactions increase, and a gram capacity of the material decreases, which is not conducive to achieving a goal of high energy density. A cross-sectional image of the negative electrode plate can be obtained by cutting the negative electrode plate perpendicularly to a surface of the negative electrode plate by using an ion milling device and observing a cross section by using a scanning electron microscope (SEM) and energy-dispersive X-ray spectroscopy (EDS). A length of the negative electrode plate in an observation region is greater than or equal to 150 μm.

For the molar ratio x of the O element to the Si element in the silicon oxide particles, an energy-dispersive X-ray spectroscopy (EDS) analysis method may be used. For example, a test is performed by using an Oxford spectrometer.

In an example, at least some surfaces (for example, a coating rate is greater than 0 and less than or equal to 100%) of the silicon-based material particles contain coating layers, which are specifically carbon coating layers. For example, a material of the carbon coating layer is selected from one or more of graphite, amorphous carbon, graphene, or a carbon nanotube.

In an example, the negative electrode active material layer includes an active material layer A and an active material layer B, and the active material layer A is disposed between the current collector and the active material layer B; the active material layer A contains the silicon-based material particles and has a thickness L_{A} meeting 35 μm≤L_{A}≤60 μm; and the active material layer B does not contain the silicon-based material particles and has a thickness L_{B} meeting 20 μm≤L_{B}≤50 μm.

In an example in which the active material layer A contains the silicon-based material particles, using a total weight of the active material layer A as a reference, a mass proportion of the silicon-based material particles ranges from 5 wt % to 25 wt %.

According to a porous electrode theory, when electronic conductivity of a solid phase is much greater than ionic conductivity of a liquid phase, polarization of the negative electrode plate is close to pure liquid-phase polarization. In an actual battery system, the electronic conductivity Kₛ of the solid phase is greater than 0.1 S/cm, the ionic conductivity K₁ of the liquid phase is less than 0.01 S/cm, and Kₛ is one or more orders of magnitude greater than K₁. Therefore, a pure liquid-phase polarization model may be used to analyze the negative electrode plate, to obtain a distribution formula of a polarization potential n as follows:

$$η ( x ) = {η}^{0} cosh [ k \cdot ( x - L ) ] / cosh ( kL ) , \qquad ( XV )$$

Herein, k=(ρₗ/Z)^{1/2}, η⁰ denotes a polarization potential on an outer surface of the negative electrode plate, ρₗ denotes an apparent specific resistance of an electrolyte solution in the negative electrode plate, Z denotes a reaction impedance per unit volume of an electrode, L denotes the thickness of the active material layer of the negative electrode plate, and x denotes a distance along a thickness direction of the electrode plate, where an outer surface of the active material layer is used as x=0 μm, and a direction facing the current collector is used as a positive direction.

According to Formula (XV), when x∈[0,L], η(x) monotonically decreases with x, when x=0 μm, n (x) reaches a maximum value η⁰, and when x=L, η(x) is a minimum value 0 V. In other words, polarization on the outer surface of the active material layer is the largest, while polarization on an inner surface in contact with the current collector is the smallest. When the active material layer of the negative electrode plate is a uniform component, under a large rate current charging condition, the outer surface is fully intercalated with lithium while the inner surface is insufficiently intercalated with lithium, and a utilization rate of the entire electrode plate is low. Therefore, uniformity of lithium intercalation in the negative electrode plate may be further improved by carrying out a proper component distribution design along the thickness direction of the electrode plate, and setting the negative electrode plate so that the active material layer A (close to the negative electrode current collector) contains the silicon-based material particles and the active material layer B (away from the negative electrode current collector) does not contain the silicon-based material particles, so that a constant-current charging ratio may be increased, fast charging performance may be improved, and cycling stability may be improved. In view of this, the lithium-ion battery made of the negative electrode plate having the active material layer A that contains silicon-based material particles has a high constant-current charging ratio and a high cycling capacity retention rate under charging conditions at 1.5 C to 4.0 C.

In another example, the negative electrode active material layer includes an active material layer A and an active material layer B, and the active material layer A is disposed between the current collector and the active material layer B; the active material layer A does not contain the silicon-based material particles and has a thickness L_{A} meeting 20 μm≤L_{A}≤40 μm; and the active material layer B contains the silicon-based material particles and has a thickness L_{B} meeting 35 μm≤L_{B}≤60 μm.

In an example in which the active material layer A does not contain the silicon-based material particles, using a total weight of the active material layer B as a reference, a mass proportion of the silicon-based material particles ranges from 5 wt % to 25 wt %.

According to a porous electrode theory, when electronic conductivity of a solid phase is much greater than ionic conductivity of a liquid phase, polarization of the negative electrode plate is close to pure liquid-phase polarization. In an actual battery system, the electronic conductivity Kₛ of the solid phase is greater than 0.1 S/cm, the ionic conductivity K₁ of the liquid phase is less than 0.01 S/cm, and Kₛ is one or more orders of magnitude greater than K₁. Therefore, a pure liquid-phase polarization model may be used to analyze the negative electrode plate, to obtain a formula of a polarization potential η⁰ on the outer surface of the negative electrode plate as follows:

$${η}^{0} = I \cdot {( {ρ}_{1} Z )}^{1 / 2} / tanh [ {( {ρ}_{1} / Z )}^{1 / 2} \cdot L ] , \qquad ( XVI )$$

Herein, I denotes a total current flowing through the negative electrode plate, ρₗ denotes an apparent specific resistance of an electrolyte solution in the negative electrode plate, Z denotes a reaction impedance per unit volume of an electrode, and L denotes the thickness of the active material layer.

According to Formula (XVI), η⁰ is proportional to I, in other words, the greater the total current flowing through the negative electrode plate, the greater the polarization potential on the surface. Under ultra-high rate fast charging conditions at 5 C to 10 C, the polarization potential on the surface of the negative electrode plate is very large. For graphite with an equilibrium lithium intercalation potential ranging from only 0.05 V to 0.2 V, a lithium deposition phenomenon is very likely to occur. The silicon-based material particles have an equilibrium lithium intercalation potential of ranging from 0.2 V to 0.6 V, and can withstand a larger polarization potential. Therefore, the silicon-based material particles can be distributed near the outer surface of the negative electrode plate to reduce a risk of lithium deposition, and no lithium deposition may occur during charging at a large current (5 C to 10 C).

According to Formula (XV), the polarization on the outer surface of the active material layer is the largest, while the polarization on the inner surface in contact with the current collector is the smallest. With reference to Formula (XVI), a greater total current I flowing through the negative electrode plate indicates a greater polarization potential η⁰ on the surface, larger unevenness of the polarization potential distribution of the negative electrode plate, and larger unevenness of lithium intercalation of the active material along the thickness direction. Therefore, for the negative electrode plate having an active material layer A that does not contain the silicon-based material particles, the silicon-based material particles are distributed near the outer surface of the negative electrode plate, which will aggravate the unevenness of the lithium intercalation. However, for the foregoing system with uneven lithium intercalation distribution, a step-by-step fast charging mode may be used, where as a charging capacity increases, a charging rate is gradually reduced. This can not only achieve fast charging but also reduce a risk of surface lithium deposition. In view of this, the lithium-ion battery made of the negative electrode plate having the active material layer A that does not contain silicon-based material particles may have stable cycling under step charging conditions at 5 C to 10 C, and is applicable to scenarios that require frequent fast charging of a small quantity of electricity.

In an example, the negative electrode active material layer further includes another negative electrode material. For example, the another negative electrode material is selected from one or more of a graphite material, a hard carbon material, or a soft carbon material.

In an example, the negative electrode active material layer further includes a conductive agent. For example, the conductive agent is selected from one or more of carbon black (Super P), acetylene black, Ketjen black, carbon fiber, single-walled carbon nanotubes (SWCNTs), or multi-walled carbon nanotubes (MWCNTs).

In an example, the negative electrode active material layer further includes a binder. For example, the binder is selected from one or more of carboxymethyl cellulose, sodium carboxymethyl cellulose, lithium carboxymethyl cellulose, hydroxypropyl cellulose, diacetyl cellulose, polyethylene, polyvinyl alcohol, polyvinyl chloride, polyvinyl fluoride, polyvinylpyrrolidone, polytetrafluoroethylene, polypropylene, polyacrylic acid, styrene-butadiene rubber (SBR), or epoxy resin.

In an example, using a total weight of the negative electrode active material layer as a reference, a weight content of the another negative electrode material ranges from 92 wt % to 99 wt %, (for example, 92 wt %, 93 wt %, 94 wt %, 95 wt %, 96 wt %, 97 wt %, 98 wt %, or 99 wt %), a weight content of the conductive agent ranges from 0.5 wt % to 4 wt % (for example, 0.5 wt %, 1 wt %, 2 wt %, 3 wt %, or 4 wt %), and a weight content of the binder ranges from 0.5 wt % to 4 wt % (for example, 0.5 wt %, 1 wt %, 2 wt %, 3 wt %, or 4 wt %).

In an example, the negative electrode current collector is selected from one or more of copper foil, carbon-coated copper foil, or porous copper foil.

The present disclosure further provides a method for preparing the foregoing negative electrode plate, including the following steps.

Silicon-based material particles, optionally other negative electrode materials, a conductive agent, and a binder are mixed to obtain a negative electrode slurry, the negative electrode slurry is then applied on a negative electrode current collector, baking and slicing are sequentially performed, followed by drying, and finally rolling and cutting are performed, to obtain a negative electrode plate.

A method for preparing a negative electrode plate having a negative electrode active material layer A that contains silicon-based material particles includes the following steps.

Silicon-based material particles, optionally other negative electrode materials, a conductive agent, and a binder are mixed to obtain a negative electrode slurry A;

optionally other negative electrode materials, a conductive agent, and a binder are mixed to obtain a negative electrode slurry B; and

the negative electrode slurry A and the negative electrode slurry B are applied on a current collector in layers, where the negative electrode slurry A is in an inner layer close to a current collector and the negative electrode slurry B is in an outer layer away from the current collector, baking and slicing are then performed, followed by drying, and finally rolling and cutting are performed, to obtain a negative electrode plate.

A method for preparing a negative electrode plate having a negative electrode active material layer A that does not contain silicon-based material particles includes the following steps.

Optionally other negative electrode materials, a conductive agent, and a binder are mixed to obtain a negative electrode slurry A;
silicon-based material particles, optionally other negative electrode materials, a conductive agent, and a binder are mixed to obtain a negative electrode slurry B; and
the negative electrode slurry A and the negative electrode slurry B are applied on a current collector in layers, where the negative electrode slurry A is in an inner layer close to a current collector and the negative electrode slurry B is in an outer layer away from the current collector, baking and slicing are then performed, followed by drying, and finally rolling and cutting are performed, to obtain a negative electrode plate.

In an example, the negative electrode slurry further contains a solvent. For example, the solvent is water.

In an example, a temperature of the baking ranges from 70° C. to 90° C., for example, 70° C., 80° C., or 90° C.

In an example, a temperature of the drying ranges from 90° C. to 110° C., for example, 90° C., 100° C., or 110° C., and a time of the drying ranges from 8 hours to 24 hours, for example, 8 hours, 10 hours, 12 hours, 24 hours, or a point value in a range formed by any two of the foregoing values.

### [Silicon-Based Material Particle and Preparation Thereof]

The present disclosure further provides silicon-based material particles for the foregoing negative electrode plate. The silicon-based material particles include at least the following characteristics:

$${D}_{v} max \leq 35 , \qquad ( VI )$$

$$9. \leq {D}_{v} 50 \leq 13. , \qquad ( VII )$$

$$and$$

$$B E T \leq 1.2 , \qquad ( VIII )$$

where
Dᵥmax represents a maximum particle size of the silicon-based material particles, in a unit of μm;
Dᵥ50 represents a median particle size of the silicon-based material particles, in a unit of μm; and
BET represents a specific surface area of the silicon-based material particles, in a unit of m²/g.

A volume of silicon-based material particles changes greatly during a lithium intercalation and deintercalation cycle, a surface SEI film may be continuously damaged and repaired, and active lithium is continuously consumed. For micron-sized particles with smooth surfaces, a larger specific surface area indicates a larger quantity of SEI films that are generated, a greater amount of damage and repair, and faster cycling capacity fading of a battery. Therefore, on the premise of ensuring that local strain does not cause deformation of an electrode plate, the particle size of the silicon-based material particles can be increased as much as possible to reduce the specific surface area of the silicon-based material particles and consumption of active lithium. However, simply increasing the particle size of the silicon-based material particles is not enough to ensure that the silicon-based material particles have a smaller specific surface area. Among all three-dimensional geometric solids, a sphere has the smallest specific surface area, while silicon-based material particles are usually formed by bulk crushing, including various irregular shapes such as rods, flakes, and polyhedrons. This feature leads to a larger specific surface area of the silicon-based material particles. Therefore, controlling a shape of silicon-based material particles can further adjust cycling performance of a negative electrode plate and a lithium-ion battery.

In the present disclosure, for the median particle size Dᵥ50 of the silicon-based material particles, a laser particle size analysis method may be used. For example, the Malvern particle size analyzer is used for measurement, and test steps are as follows: Silicon-based material particles were dispersed in deionized water containing a dispersing agent (such as nonylphenol polyoxyethylene ether, with a content of about 0.03 wt %) to form a mixture, ultrasonic treatment was performed on the mixture for 2 minutes, and a resulting mixture is then placed in the Malvern particle size analyzer for analysis.

For the specific surface area BET of the silicon-based material particles, a BET (Brunauer-Emmett-Teller) analysis method may be used. For example, a TriStar II surface area analyzer is used for measurement.

The present disclosure further provides a method for preparing silicon oxide particles, and the preparation method includes the following steps.
(1) Silicon powder and silicon dioxide powder are mixed according to a molar ratio of Si/SiO₂ ranging from 0.33 to 3.00, to obtain a mixture.
(2) Under atmospheric pressure ranging from 10⁻⁶ MPa to 10⁻⁴ MPa, at a temperature ranging from 1000° C. to 1200° C., the mixture is made to react for 4 hours to 10 hours to generate a gas.
(3) The gas is condensed to obtain a solid.
(4) The solid is pulverized to obtain powder A.
(5) Carbon coating is performed on the powder A to obtain powder B.
(6) Particle size classification is performed on the powder B to obtain the silicon oxide particles.

In an example, in Step (1), the mixing may be performed by a horizontal mixer, an airflow mixer, or a horizontal ball mill.

In an example, the pulverization in Step (4) includes primary pulverization and secondary pulverization. The primary pulverization aims to grind the solid into powder, and the secondary pulverization aims to round off corners of the powder particles to make the particle shape tend to be spherical. The primary pulverization may be performed by a horizontal ball mill, and the secondary pulverization may be performed by a vibration ball mill. A container used for the primary pulverization and the secondary pulverization is made of stainless steel, and a ball milling bead may be made of stainless steel or zirconia. In the primary pulverization and the secondary pulverization, a total filling volume of a solid to be pulverized and the ball milling bead ranges from 25% to 40% of a volume of the container. In the primary pulverization, a diameter of the ball milling bead ranges from 1 cm to 2 cm, a mass ratio of the solid to be pulverized to the ball milling bead ranges from 0.05 to 0.15, rotational frequency of the container ranges from 200 rpm to 300 rpm, and a ball milling time ranges from 8 hours to 12 hours. In the secondary pulverization, a diameter of the ball milling bead ranges from 0.3 cm to 1 cm, a mass ratio of the solid to be pulverized to the ball milling bead ranges from 0.3 to 0.5, vibrational frequency of the container ranges from 400 rpm to 800 rpm, and a ball milling time ranges from 5 hours to 8 hours.

In an example, in Step (5), a method for the carbon coating includes chemical vapor deposition.

In an example, the chemical vapor deposition method includes the following steps. High-temperature calcination treatment is performed on the powder A in a carbon source gas atmosphere to prepare the powder B.

In an example, the carbon source gas may be a mixed gas of argon and acetylene (C₂H₂). For example, in the mixed gas, acetylene (C₂H₂) accounts for 3% to 20% by volume, for example, 3%, 5%, 8%, 10%, 15%, 20%, or a point value in a range formed by any two of the foregoing values.

In an example, a mass ratio of a carbon source gas flowing per minute to the silicon oxide particles ranges from 0.05% to 0.4%, for example, 0.05%, 0.1%, 0.2%, 0.3%, 0.4%, or a point value in a range formed by any two of the foregoing values.

In an example, a temperature of the high-temperature calcination treatment ranges from 600° C. to 800° C., for example, 600° C., 700° C., and 800° C., and a time of the high-temperature calcination treatment ranges from 3 minutes to 60 minutes, for example, 3 minutes, 5 minutes, 8 minutes, 10 minutes, 20 minutes, 30 minutes, 40 minutes, 50 minutes, or 60 minutes. Further, a heating rate of the high-temperature calcination treatment ranges from 5° C./min to 15° C./min, for example, 5° C./min, 10° C./min, or 15° C./min.

In an example, the high-temperature calcination treatment is performed in an inert atmosphere. For example, the high-temperature calcination treatment is performed in a nitrogen atmosphere or in an argon atmosphere.

According to an exemplary implementation of the present disclosure, the method for the carbon coating includes the following steps.
(i) Under protection of argon, the powder A is heated to 600° C. to 800° C.
(ii) a mixed gas of argon and acetylene with a content of C₂H₂ ranges from 3% to 20%, and a reaction time ranges from 3 minutes to 60 minutes.
(iii) Under protection of argon, a resulting mixture is naturally cooled to room temperature to obtain the powder B.

In an example, in Step (6), the particle size classification aims to obtain the silicon oxide particles with Dᵥmax and Dᵥ50 meeting Formula (VI) and Formula (VII), where a method used includes air classification.

### [Lithium-Ion Battery]

The present disclosure further provides a lithium-ion battery, where the lithium-ion battery includes the foregoing negative electrode plate.

According to the present disclosure, after one to five charge-discharge cycles are performed for the lithium-ion battery, irreversible expansion occurs in the negative electrode plate, and in this case, the negative electrode plate meets the following relationship:

$${D}_{i}^{′} \leq 44 µm , \qquad ( IX )$$

$${d}_{i}^{′} \leq 32 µm , \qquad ( X )$$

$$0.45 \leq ( \sum {E}_{j}^{′2} ) / ( \sum {D}_{i}^{′2} ) \leq 0 \text{.75} , \qquad ( XI )$$

$$( \sum {F}_{k}^{′2} ) / ( \sum {D}_{i}^{′2} ) \geq 0 \text{.37} , \qquad ( XII )$$

$$0.06 \leq ( \sum {F}_{k}^{′2} ) / {S}^{′} \leq 0.53 , \qquad ( XIII )$$

$$and$$

$$39 µm \leq {L}^{′} \leq 130 µm , \qquad ( XIV )$$

where
Σ represents performing summation on data, Dᵢ′ represents a diameter of a circumscribed circle of any silicon-based material particle, in a unit of μm, dᵢ′ represents a diameter of an inscribed circle of any silicon-based material particle, in a unit of μm, Eⱼ′ represents a diameter of a circumscribed circle of a silicon-based material particle having Dᵢ′≥11.2 μm, in a unit of μm, Fₖ′ represents a diameter of a circumscribed circle of a silicon-based material particle having dᵢ′≥5.0 μm, in a unit of μm, i, j, and k represent numbers of silicon-based material particles, S′ represents a cross-sectional area of the negative electrode plate in an observation region, in a unit of μm², and L′ represents a thickness of an active material layer, in a unit of μm.

In an example, the negative electrode plate includes a negative electrode current collector and a negative electrode active material layer, the negative electrode active material layer is disposed on at least one surface of the negative electrode current collector, the negative electrode active material layer includes an active material layer A and an active material layer B, and the active material layer A is disposed between the current collector and the active material layer B.

In an example, an active material layer A close to a negative electrode current collector contains silicon-based material particles, and an active material layer B away from the negative electrode current collector does not contain silicon-based material particles; and after the one to five charge-discharge cycles are performed for the lithium-ion battery, a thickness L_{A}′ of the active material layer A meets 44 μm≤L_{A}′≤75 μm, and a thickness L_{B}′ of the active material layer B meets 21 μm≤L_{B}′≤55 μm.

In another example, an active material layer A close to a negative electrode current collector does not contain silicon-based material particles, and an active material layer B away from the negative electrode current collector contains silicon-based material particles; and after the one to five charge-discharge cycles are performed for the lithium-ion battery, a thickness L_{A}′ of the active material layer A meets 21 μm≤L_{A}′≤44 μm, and a thickness L_{B}′ of the active material layer B meets 44 μm≤L_{B}′≥75 μm.

In an example, the lithium-ion battery further includes a positive electrode plate.

In an example, the positive electrode plate includes a positive electrode current collector and a positive electrode active material layer applied on a surface the positive electrode current collector. Preferably, the positive electrode active material layer includes a positive electrode material.

In an example, the positive electrode current collector is selected from one or more of aluminum foil, carbon-coated aluminum foil, or porous aluminum foil.

In an example, the positive electrode material is selected from one or more of one of more of lithium iron phosphate, lithium manganese phosphate, lithium vanadium phosphate, lithium iron silicate, lithium cobalt oxide (LCO), a nickel-cobalt-manganese ternary material, a lithium nickel cobalt aluminate ternary material, lithium nickel oxide, a nickel-manganese/cobalt-manganese/nickel-cobalt binary material, lithium manganese oxide, or a lithium-rich manganese-based material.

In an example, the lithium-ion battery further includes a separator. For example, the separator is selected from one or more of a polyethylene separator or a polypropylene separator.

In an example, the lithium-ion battery further includes an electrolyte solution. Preferably, the electrolyte solution is a non-aqueous electrolyte solution, and the non-aqueous electrolyte solution includes a solvent and a lithium salt.

For example, the solvent is selected from one or more of ethylene carbonate (EC), propylene carbonate (PC), propyl propionate (PP), diethyl carbonate (DEC), fluoroethylene carbonate (FEC), 1,3-propane sultone (PS), dimethyl carbonate (DMC), or ethyl methyl carbonate (EMC).

The lithium salt is selected from one or more of LiPF₆, LiBF₄, LiSbF₆, LiClO₄, LiCF₃SO₃, LiAlO₄, LiAlCl₄, Li(CF₃SO₂)₂N, LiBOB, or LiDFOB.

In an example, the lithium-ion battery further includes a packaging housing. For example, the packaging housing is selected from one or more of an aluminum-plastic film, an aluminum housing, or a steel housing.

In the present disclosure, for the median particle size Dᵥ50 of the silicon-based material particles, a laser particle size analysis method may be used. For example, the Malvern particle size analyzer is used for measurement, and test steps are as follows: Silicon-based material particles were dispersed in deionized water containing a dispersing agent (such as nonylphenol polyoxyethylene ether, with a content of about 0.03 wt %) to form a mixture, ultrasonic treatment was performed on the mixture for 2 minutes, and a resulting mixture is then placed in the Malvern particle size analyzer for analysis.

For the specific surface area BET of the silicon-based material particles, a BET (Brunauer-Emmett-Teller) analysis method may be used. For example, a TriStar II surface area analyzer is used for measurement.

For the molar ratio x of the O element to the Si element in the silicon oxide particles, an energy-dispersive X-ray spectroscopy (EDS) analysis method may be used. For example, a test is performed by using an Oxford spectrometer.

The following further describes the technical solutions of the present disclosure in detail with reference to specific embodiments. It should be understood that the following embodiments are merely for the purposes of illustrating and explaining the present disclosure, and should not be construed as limiting the scope of protection of the present disclosure. Any technology implemented based on the foregoing contents of the present disclosure falls within the intended scope of protection of the present disclosure.

Unless otherwise stated, raw materials and reagents used in the following embodiments are commercially available commodities, or may be prepared by a known method.

In the following examples and comparative examples of the present disclosure, electrical performance test methods of a silicon-based material particle, a negative electrode plate, and a lithium-ion battery are as follows.

### 1. Button Battery Manufacturing and Test Method:

Silicon oxide particles, sodium carboxymethyl cellulose (CMC-Na), styrene-butadiene rubber (SBR), carbon black (Super P), and single-walled carbon nanotubes (SWCNTs) were mixed in a mass ratio of 85:2:5.5:7:0.5, and deionized water was added. A resulting mixture was stirred under action of a vacuum mixer to obtain a negative electrode slurry, and the negative electrode slurry was applied on copper foil. The copper foil was baked at 80° C. and sliced, and then transferred to a vacuum oven for drying at 100° C. for 12 hours. After rolling in a dry environment, a press density was about 1.4 g/cm³, and then a punching machine was used to make disks with a diameter of about 1.2 cm.

In an inert gas atmosphere, 13 wt % fully dried lithium hexafluorophosphate (LiPF₆) and 10 wt % fluoroethylene carbonate (FEC) were quickly added to ethylene carbonate (EC), a resulting mixture was stirred evenly to obtain a required electrolyte solution.

In a glove box, a metal lithium plate as a counter electrode, a polyethylene separator as a separator, and an electrolyte solution added were assembled into a button battery.

A LAND test system was used. The battery was discharged to 0.005 V at a current of 50 mA/g, left standing for 10 minutes, and then charged to 1.5 V at 50 mA/g to calculate a gram capacity and initial efficiency of a negative electrode material.

### EXAMPLES

### 1. Preparation and Physicochemical Parameters of Silicon Oxide Particles

The following gives an example method for preparing silicon oxide particles.
(1) Silicon powder and silicon dioxide powder are mixed according to a molar ratio of Si/SiO₂ ranging from 0.33 to 3.00, to obtain a mixture.
(2) Under atmospheric pressure of 2×10 5 MPa, at a temperature of 1050° C., the mixture is made to react for 6 hours to generate a gas.
(3) The gas is condensed to obtain a solid.
(4) The solid is pulverized to obtain powder A.
(5) Carbon coating is performed on the powder A to obtain powder B.
(6) Particle size classification is performed on the powder B to obtain the silicon oxide particles.

The pulverization in Step (4) includes primary pulverization and secondary pulverization. In the primary pulverization, a total filling volume of a material to be pulverized and a ball milling bead is 30% of a volume of the container, a diameter of the ball milling bead is 1.5 cm, a mass ratio of the material to be pulverized to the ball milling bead is 0.1, and a ball milling time is 10 hours. In the secondary pulverization, a total filling volume of a material to be pulverized and a ball milling bead is 30% of the volume of the container, a diameter of the ball milling bead is 0.5 cm, a mass ratio of the material to be pulverized to the ball milling bead is 0.4, and a ball milling time is 6 hours.

In Step (5), in the mixed gas, acetylene (C₂H₂) accounts for 5%, a mass ratio of a carbon source gas flowing per minute to the silicon oxide particles is 0.2%, a temperature of calcination treatment is 700° C., and a calcination time is 15 minutes.

Table 1 gives preparation parameters in Examples and Comparative Examples, including a molar ratio of Si/SiO₂ in Step (1) and vibrational frequency of a ball mill in secondary pulverization in Step (4). Table 1 further gives physicochemical parameters of silicon oxide particles in Examples and Comparative Examples, including a molar ratio x of O/Si, a maximum particle size D max, a median particle size Dᵥ50, a specific surface area BET, and a gram capacity and initial efficiency of silicon oxide particles.

In primary pulverization of Examples 1 to 3 and Comparative Examples 1 to 5, rotational frequency of a container was 250 rpm. In primary pulverization of Comparative Example 6, rotational frequency of a container was 500 rpm.

TABLE 1

| | | Vibrational | | | | | | |
|---|---|---|---|---|---|---|---|---|
| | | frequency in | | | | | | |
| | Molar | secondary | Molar | | | | Gram | |
| | ratio of | pulverization | ratio x of | Dᵥmax | Dᵥ50 | BET | capacity | Initial |
| | Si/SiO₂ | (rpm) | O/Si | (μm) | (μm) | (m²/g) | (mAh/g) | efficiency |
| Example 1 | 0.8 | 600 | 1.12 | 28 | 9.8 | 0.92 | 1589 | 74.7% |
| Example 2 | 1.2 | 600 | 0.91 | 29 | 9.5 | 0.99 | 1748 | 78.3% |
| Example 3 | 0.8 | 400 | 1.12 | 34 | 12.3 | 0.84 | 1580 | 74.5% |
| Comparative | 0.3 | 600 | 1.55 | 30 | 9.7 | 0.95 | 1114 | 65.2% |
| Example 1 | | | | | | | | |
| Comparative | 2.0 | 600 | 0.66 | 31 | 9.9 | 1.05 | 2089 | 81.6% |
| Example 2 | | | | | | | | |
| Comparative | 0.8 | 100 | 1.12 | 42 | 14.7 | 0.81 | 1577 | 74.6% |
| Example 3 | | | | | | | | |
| Comparative | 0.8 | 1200 | 1.12 | 19 | 6.2 | 2.76 | 1592 | 74.7% |
| Example 4 | | | | | | | | |
| Comparative | 0.8 | 1500 | 1.12 | 15 | 5.3 | 4.57 | 1601 | 74.8% |
| Example 5 | | | | | | | | |
| Comparative | 0.8 | \ | 1.12 | 35 | 12.8 | 2.03 | 1573 | 74.5% |
| Example 6 | | | | | | | | |

Physical properties of the silicon oxide particles in Examples 1 to 3 all met requirements of the present disclosure.

Example 1 was a reference group. Example 2 differed from Example 1 in that the molar ratio of O/Si ranged from 1.0 to 1.4 in Example 1 in comparison with that ranging from 0.7 to 1.0 in Example 2. Example 3 differed from Example 1 in the particle size, where Dᵥ50 in Example 1 ranged from 9.0 μm to 11.0 μm, while Dᵥ50 in Example 3 ranged from 11.0 μm to 13.0 μm.

The silicon oxide particles of Comparative Examples 1 to 6 did not fully meet requirements of the present disclosure. The characteristics were indicated in bold italics in the table, where the molar ratio of O/Si in Comparative Example 1 was greater than 1.4; the molar ratio of O/Si in Comparative Example 2 was less than 0.7; in Comparative Example 3, the vibrational frequency of the container was too low during the secondary pulverization, a pulverization effect was poor, and Dᵥ50 of the silicon oxide particles was greater than 13.0 μm; in Comparative Examples 4 and 5, during the secondary pulverization, the vibrational frequency of the container was too high, pulverization intensity was too large, and Dᵥ50 of the silicon oxide particles was less than 9.0 μm, and due to a decrease in the particle size, the specific surface area increased, the BET was greater than 1.2 m²/g; and in Comparative Example 6, the rotational frequency of the container in the primary pulverization was increased while the secondary pulverization step was omitted, and in this case, the silicon oxide particles retained more corners, and the BET was greater than 1.2 m²/g.

It may be learned from Table 1 that:
Example 1, Example 3, and Comparative Examples 3 to 6 each had a molar ratio of O/Si of the silicon oxide particles being 1.12, and had similar gram capacities ranging from 1570 mAh/g to 1610 mAh/g and similar initial efficiency ranging from 74% to 75%; and
the molar ratios of O/Si in Comparative Example 1, Example 1, Example 2, and Comparative Example 2 decreased successively and were 1.55, 1.12, 0.91, and 0.66 respectively, and corresponding gram capacities and initial efficiency also increased successively. The reason for this phenomenon is that a lower content of oxygen indicates fewer irreversible reactions involving oxygen.

FIG. 2 shows a volume-based particle size distribution curve of silicon oxide particles in Example 1. It may be learned from the curve that a volume of silicon oxide particles having a particle size ≥9.8 μm accounts for about 50%, and the maximum particle size is about 28 μm. Through this particle size distribution control, a proportion of silicon oxide particles with larger particle sizes is increased, which is beneficial to reducing a specific surface area of the silicon oxide particles.

FIG. 3 is a SEM image (taken in a secondary electron mode) of the silicon oxide particles in Example 1. It may be learned from the figure that there are very few silicon oxide particles in the form of flakes, rods, or wedges, or having sharp edges, thereby ensuring that the silicon oxide particles have a smaller specific surface area.

### 2. Preparation and Physical Property Parameters of a Negative Electrode Plate, and Preparation and Physical Property Parameters of a Lithium-Ion Battery

### Example I Group

The Example I group is used to describe a negative electrode plate and a lithium-ion battery of the present disclosure that have a negative electrode active material layer including silicon oxide particles.

### (1) The Following Gives an Example of a Method for Preparing a Negative Electrode Plate.

Silicon oxide particles, graphite having Dᵥ50 of 15 μm, sodium carboxymethyl cellulose (CMC-Na), styrene-butadiene rubber (SBR), carbon black (Super P), and single-walled carbon nanotubes (SWCNTs) were mixed in a mass ratio of y:(96-y):1.5:1.5:0.9:0.1, and deionized water was added. A resulting mixture was stirred under action of a vacuum mixer to obtain a negative electrode slurry. The negative electrode slurry was evenly applied on copper foil having a thickness of 6 μm at a surface density of 8 mg/cm². The copper foil was baked at 80° C., and then transferred to a vacuum oven for drying at 100° C. for 12 hours, followed by rolling at a press density of 1.6 g/cm³ and cutting, to obtain a negative electrode plate.

Table 2 gives preparation conditions of negative electrode plates in Examples I1 to I4 and Comparative Examples I1 to I9, including silicon oxide particles used and mixing amounts thereof, where a mass proportion of the silicon oxide particles (namely, a ratio of a weight of the silicon oxide particles to a sum of the weight of the silicon oxide particles and a weight of graphite) is obtained by Formula y/96. Table 2 further gives physical property parameters of the silicon oxide particles in the negative electrode plate, including a maximum value of a diameter Dᵢ of a circumscribed circle, a maximum value of a diameter dᵢ of an inscribed circle, (ΣEⱼ²)/(ΣDᵢ²), (ΣFₖ²)/(ΣDᵢ²), (ΣFₖ²)/S, and a thickness L of a negative electrode active material layer.

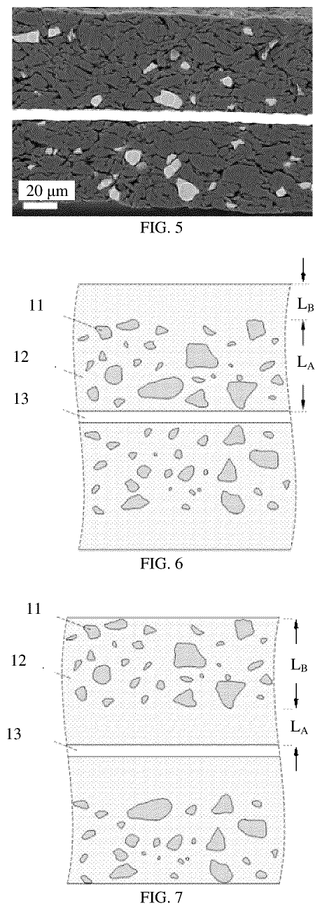

For example, FIG. 4 and FIG. 5 each show a SEM cross-sectional image of a negative electrode plate in Example I1 of the present disclosure, in which 41 represents silicon oxide particles, 42 represents graphite, and 43 represents copper foil. Then, Dᵢ may be obtained by measuring a diameter of a circumscribed circle of each silicon oxide particle, dᵢ may be obtained by measuring a diameter of an inscribed circle of each silicon oxide particle, Eⱼ may be obtained by measuring a diameter of a circumscribed circle of a silicon oxide particle having Dᵢ≥9 μm, and Fₖ may be obtained by measuring a diameter of a circumscribed circle of a silicon oxide particle having dᵢ≥4 μm. S represents a cross-sectional area of a negative electrode active material layer in an observation region of the SEM image. Then, the measured diameter Dᵢ of the circumscribed circle of each silicon oxide particle, the measured diameter Eⱼ of the circumscribed circle of each silicon oxide particle having Dᵢ≥9 μm, and the measured diameter Fr of the circumscribed circle of each silicon oxide particle having dᵢ≥4 μm are separately squared and then summed, to obtain ΣEⱼ², ΣDᵢ², and ΣFₖ², and then calculate values of (ΣEⱼ²)/(ΣDᵢ²), (ΣFₖ²)/(ΣDᵢ²), and (ΣFₖ²)/S. Diameters of inscribed circles of these particles in FIG. 5 are ≥4 μm.

TABLE 2

| | Silicon | | Maximum | Maximum | | | | |
|---|---|---|---|---|---|---|---|---|
| | oxide | Mass | value of Dᵢ | value of dᵢ | (ΣEⱼ²)/ | (ΣFₖ²)/ | (ΣFₖ²)/ | L |
| | particles | proportion | (μm) | (μm) | (ΣDᵢ²) | (ΣDᵢ²) | S | (μm) |
| Example I1 | Example 1 | 10% | 27 | 19 | 0.62 | 0.66 | 0.09 | 57 |
| Example I2 | Example 2 | 10% | 26 | 18 | 0.59 | 0.64 | 0.09 | 57 |
| Example I3 | Example 3 | 10% | 32 | 23 | 0.69 | 0.76 | 0.11 | 57 |
| Comparative | Comparative | 10% | 26 | 17 | 0.59 | 0.65 | 0.10 | 57 |
| Example I1 | Example 1 | | | | | | | |
| Comparative | Comparative | 10% | 27 | 17 | 0.60 | 0.62 | 0.09 | 57 |
| Example I2 | Example 2 | | | | | | | |
| Comparative | Comparative | 10% | 38 | 28 | 0.78 | 0.34 | 0.13 | 57 |
| Example I3 | Example 3 | | | | | | | |
| Comparative | Comparative | 10% | 17 | 11 | 0.18 | 0.31 | 0.07 | 57 |
| Example I4 | Example 4 | | | | | | | |
| Comparative | Comparative | 10% | 13 | 7 | 0.08 | 0.07 | 0.02 | 57 |
| Example I5 | Example 5 | | | | | | | |
| Comparative | Comparative | 10% | 33 | 21 | 0.73 | 0.35 | 0.16 | 57 |
| Example I6 | Example 6 | | | | | | | |
| Example I4 | Example 1 | 20% | 26 | 16 | 0.58 | 0.63 | 0.28 | 45 |
| Comparative | Example 1 | 3% | 25 | 19 | 0.59 | 0.65 | 0.04 | 70 |
| Example I7 | | | | | | | | |
| Comparative | Example 1 | 30% | 28 | 17 | 0.58 | 0.66 | 0.48 | 40 |
| Example I8 | | | | | | | | |
| Comparative | Example 1 | 10% | 27 | 18 | 0.62 | 0.65 | 0.10 | 120 |
| Example I9 | | | | | | | | |

The negative electrode plates in Examples I1 to I4 all met requirements of the present disclosure. Example I1 was a reference group. Example 12 differed from Example I1 only in that the silicon oxide particles used in Example 12 had a lower molar ratio of O/Si. Example 13 differed from Example I1 in that the silicon oxide particles used in Example 13 had lower secondary vibrational frequency during synthesis, and therefore had larger Dᵥmax and Dᵥ50, a higher proportion of large-size particles, and larger corresponding (ΣEⱼ²)/(ΣDⱼ²) and (ΣFₖ²)/(ΣDᵢ²). Example 14 differed from Example I1 in that Example I4 had larger (ΣFₖ²)/S, in other words, had a larger mixing amount of silicon oxide particles.

The negative electrode plates in Comparative Examples I1 to I9 could not fully meet requirements of the present disclosure (these characteristics were indicated in bold italics in Table 2), where the molar ratio of O/Si of the silicon oxide particles in Comparative Example I1 was greater than 1.4; the molar ratio of O/Si of the silicon oxide particles in Comparative Example 12 was less than 0.7; for the negative electrode plate in Comparative Example 13, a maximum value of Dᵢ was greater than 35 μm, a maximum value of dᵢ was greater than 25 μm, (ΣEⱼ²)/(ΣDᵢ²) was greater than 0.75, and (ΣFₖ²)/(ΣDᵢ²) was less than 0.37, and it may be learned from comparison and analysis that the vibrational frequency was too low during the secondary pulverization of the silicon oxide particles used in the negative electrode plate, and therefore, corners of the particles were not fully rounded off, thus exhibiting a larger diameter of circumscribed circle, which also makes the value of (ΣFₖ²)/(ΣDᵢ²) relatively reduced; for the negative electrode plate in Comparative Example 14, (ΣEⱼ²)/(ΣDᵢ²) was less than 0.45 and (ΣFₖ²)/(ΣDᵢ²) was less than 0.37, this was because the vibrational frequency was too high during the secondary pulverization of the silicon oxide particles used in the negative electrode plate, resulting in the particle size being too small, and as a result, parameters related to a circumscribed circle and an inscribed circle could not meet the requirements; for the negative electrode plate in Comparative Example 15, (ΣEⱼ²)/(ΣDᵢ²) and (ΣFₖ²)/(ΣDᵢ²) were lower than those in Comparative Example 14, this was because the vibrational frequency of the container was too high during the secondary pulverization of the silicon oxide particles used in the negative electrode plate, resulting in the particle size of the silicon oxide particles being smaller; for the negative electrode plate in Comparative Example 16, (ΣFₖ²)/(ΣDᵢ²) was less than 0.37, this was because only primary pulverization was used for the silicon oxide particles used in the negative electrode plate for particle size refinement and the rotational frequency of the container was too high during the pulverization, and as a result, the particles retained more corners; for the negative electrode plate in Comparative Example 17, (ΣFₖ²)/S was too low, this was because the mixing amount of the silicon oxide particles was too small; for the negative electrode plate in Comparative Example 18, (ΣFₖ²)/S was too high, this was because the mixing amount of the silicon oxide particles was too large; and for the negative electrode plate in Comparative Example 19, the active material layer was thicker than 100 μm.

It may be learned from the cross section of the negative electrode plate in Example I1 shown in FIG. 4 (or FIG. 5) that the electrode plate included a higher proportion of silicon oxide particles having Dᵢ≥9 μm and dᵢ≥4 μm. When the mixing amount of the silicon oxide particle was relatively high (5% to 25%), this design could effectively reduce side reactions on the surface of the silicon oxide particles and improve cycling stability of the electrode plate.

### (2) Method for Preparing a Lithium-Ion Battery:

Silicon oxide particles, graphite having Dᵥ50 of 15 μm, sodium carboxymethyl cellulose (CMC-Na), styrene-butadiene rubber (SBR), carbon black (Super P), and single-walled carbon nanotubes (SWCNTs) were mixed in a mass ratio of y:(96-y):1.5:1.5:0.9:0.1, and deionized water was added. A resulting mixture was stirred under action of a vacuum mixer to obtain a negative electrode slurry. The negative electrode slurry was evenly applied on copper foil having a thickness of 6 μm. The copper foil was baked at 80° C., and then transferred to a vacuum oven for drying at 100° C. for 12 hours, followed by rolling and cutting, to obtain a negative electrode plate.

Lithium cobalt oxide (LCO), polyvinylidene fluoride (PVDF), and carbon black (Super P) were mixed in a mass ratio of 96:2:2, and N-methylpyrrolidone (NMP) was added. A resulting mixture was stirred under action of a vacuum mixer until a uniform positive electrode slurry was formed. The positive electrode slurry was evenly applied on aluminum foil having a thickness of 12 μm. The coated aluminum foil was baked in an oven, and then transferred to an oven for drying at 120° C. for 8 hours, followed by rolling at a press density of 4.0 g/cm³ and cutting, to obtain a required positive electrode plate. A size of the positive electrode plate was less than that of the negative electrode plate to avoid lithium deposition at an edge of the negative electrode plate. An initial lithium deintercalation capacity per unit area of the positive electrode plate was 2% lower than initial lithium intercalation capacity per unit area of the negative electrode plate, to ensure that the negative electrode plate had sufficient lithium storage sites to avoid lithium deposition on the negative electrode plate.

In an inert gas atmosphere, a mixed solution was prepared in a mass ratio of EC:PC:PP:LiPF₆:FEC:PS=13:13:50:15:5:4, and the mixed solution was stirred evenly to obtain a required electrolyte solution.

A polyethylene separator having a thickness of 8 μm was used.

A layer of lithium foil was attached to the surface of the negative electrode plate by a roll-pressing method to obtain a pre-lithiated negative electrode plate, so that initial efficiency of the pre-lithiated negative electrode plate in the button battery test reached 91.2% to 92.2%.

The positive electrode plate, the separator, and the pre-lithiated negative electrode plate prepared above were sequentially stacked to ensure that the separator was located between the positive electrode plate and the negative electrode plate for separation, and then winding was performed to obtain a bare cell without liquid injection. The bare cell was placed in an aluminum-plastic film housing, the prepared electrolyte solution was injected into the dried bare cell, and after processes such as vacuum packaging, standing, forming, shaping, and sorting, the lithium-ion battery required was obtained.

Preparation of the pre-lithiated negative electrode plate used striped lithium foil having a thickness of 5 μm, where lithium foil sections and blank sections were alternately and repeatedly distributed. Widths of the lithium foil sections and blank sections in Examples and Comparative Examples were as follows. In Example 15, Example 17, Comparative Examples 112 to 115, and Comparative Example 118, a width of a lithium foil section was 0.2 cm, and a width of a blank section was 0.8 cm; in Example 16 and Comparative Example I11, a width of a lithium foil section was 0.15 cm, and a width of a blank section was 0.85 cm; in Example 18, a width of a lithium foil section was 0.5 cm, and a width of a blank section was 0.5 cm; in Comparative Example 110, a width of a lithium foil section was 0.3 cm, and a width of a blank section was 0.7 cm; in Comparative Example I16, no lithium pre-lithiation was involved; and in Comparative Example 117, a width of a lithium foil section was 0.8 cm, and a width of a blank section was 0.2 cm.

Two charge-discharge cycles were performed according to the foregoing cycle system, and the battery was disassembled to obtain a negative electrode plate.

Table 3 gives physical property parameters of the negative electrode plates after the two cycles were performed for the lithium-ion batteries in Examples 15 to 18 and Comparative Examples 110 to 118, including a maximum value of a diameter Dᵢ′ of a circumscribed circle, a maximum value of a diameter dᵢ′ of an inscribed circle, (ΣEⱼ′2)/(ΣDᵢ′²), (ΣF_{K}′²)/(ΣDᵢ′²), (ΣFₖ′²)/S, and a thickness L′ of an active material layer. It should be noted that after two charge-discharge cycles were performed for the battery, a thickness change ((L′−L)/L*100%) of the active material layer of the negative electrode plate ranged from 10% to 50%, which is a normal phenomenon.

TABLE 3

| | | | | Maximum | Maximum | | | | |
|---|---|---|---|---|---|---|---|---|---|
| | Negative | Silicon | | value | value | | | | |
| | electrode | oxide | Mass | of Dᵢ′ | of dᵢ′ | (ΣEⱼ′²)/ | (ΣFₖ′²)/ | (ΣFₖ′²)/ | L′ |
| | plate | particles | proportion | (μm) | (μm) | (ΣDᵢ′²) | (ΣDᵢ′²) | S | (μm) |
| Example I5 | Example I1 | Example 1 | 10% | 34 | 25 | 0.59 | 0.65 | 0.12 | 72 |
| Example I6 | Example I2 | Example 2 | 10% | 32 | 25 | 0.57 | 0.63 | 0.13 | 73 |
| Example I7 | Example I3 | Example 3 | 10% | 41 | 30 | 0.68 | 0.77 | 0.13 | 71 |
| Comparative | Comparative | Comparative | 10% | 33 | 24 | 0.57 | 0.63 | 0.14 | 72 |
| Example I10 | Example I1 | Example 1 | | | | | | | |
| Comparative | Comparative | Comparative | 10% | 34 | 25 | 0.58 | 0.64 | 0.11 | 73 |
| Example I11 | Example I2 | Example 2 | | | | | | | |
| Comparative | Comparative | Comparative | 10% | 49 | 33 | 0.80 | 0.29 | 0.16 | 76 |
| Example I12 | Example I3 | Example 3 | | | | | | | |
| Comparative | Comparative | Comparative | 10% | 23 | 14 | 0.21 | 0.27 | 0.09 | 73 |
| Example I13 | Example I4 | Example 4 | | | | | | | |
| Comparative | Comparative | Comparative | 10% | 17 | 9 | 0.09 | 0.08 | 0.03 | 73 |
| Example I14 | Example I5 | Example 5 | | | | | | | |
| Comparative | Comparative | Comparative | 10% | 42 | 29 | 0.71 | 0.36 | 0.15 | 74 |
| Example I15 | Example I6 | Example 6 | | | | | | | |
| Example I8 | Example I4 | Example 1 | 20% | 34 | 28 | 0.56 | 0.65 | 0.31 | 56 |
| Comparative | Comparative | Example 1 | 3% | 33 | 28 | 0.57 | 0.63 | 0.05 | 89 |
| Example I16 | Example I7 | | | | | | | | |
| Comparative | Comparative | Example 1 | 30% | 34 | 26 | 0.59 | 0.63 | 0.55 | 57 |
| Example I17 | Example I8 | | | | | | | | |
| Comparative | Comparative | Example 1 | 10% | 33 | 25 | 0.58 | 0.64 | 0.14 | 163 |
| Example I18 | Example I9 | | | | | | | | |

The data conclusions given in Table 3 are similar to those in Table 2 and are not repeated herein.

### Test Example I

Cycling performance tests were performed on the lithium-ion batteries obtained in the Example I group and Comparative Examples.

A test method for the lithium-ion battery is as follows.

A LAND test system was used and a test temperature was 25° C.

The battery was charged to 4.45 V at a constant current of 0.7 C, charged to 0.05 C at a constant voltage, left standing for 10 minutes, and then discharged to 3.0 V at 0.2 C, to obtain a discharge capacity and discharge energy. The discharge capacity was used as a nominal capacity, and the discharge energy was used as energy of the battery.

The battery was charged to 3.88 V at a constant current of 0.7 C and charged to 0.02 C at a constant voltage. A thickness of the battery in this case was measured and used as an initial thickness of the battery. A product of the initial thickness, a length, and a width of the battery was used as an initial volume of the battery, and the energy of the battery divided by the initial volume of the battery was used as energy density of the battery.

The charge-discharge step in which the battery was charged to 4.45 V at a constant current of 0.7 C, charged to 0.05 C at a constant voltage, left standing for 10 minutes, discharged to 3.0 V at 1 C, and then left standing for 10 minutes was used as a cycle. The highest discharge capacity in the first three cycles was used as an initial capacity of the battery, and a ratio of the capacity in each step to the initial capacity was used as a capacity retention rate of the battery. Cycling was performed until the capacity retention rate was less than 80%.

Table 4 gives energy density and quantities of cycles when the capacity retention rate was 80% of the lithium-ion batteries in Examples 15 to 18 and Comparative Examples I10 to I18.

TABLE 4

| | Negative | Silicon | Mass | Energy | Quantity |
|---|---|---|---|---|---|
| | electrode | oxide | propor- | density | of |
| | plate | particles | tion | (Wh/L) | cycles |
| Example I5 | Example I1 | Example 1 | 10% | 744 | 803 |
| Example I6 | Example I2 | Example 2 | 10% | 756 | 778 |
| Example I7 | Example I3 | Example 3 | 10% | 745 | 811 |
| Comparative | Comparative | Comparative | 10% | 698 | 801 |
| Example I10 | Example I1 | Example 1 | | | |
| Comparative | Comparative | Comparative | 10% | 769 | 473 |
| Example I11 | Example I2 | Example 2 | | | |
| Comparative | Comparative | Comparative | 10% | 738 | 582 |
| Example I12 | Example I3 | Example 3 | | | |
| Comparative | Comparative | Comparative | 10% | 748 | 601 |
| Example I13 | Example I4 | Example 4 | | | |
| Comparative | Comparative | Comparative | 10% | 745 | 507 |
| Example I14 | Example I5 | Example 5 | | | |
| Comparative | Comparative | Comparative | 10% | 746 | 542 |
| Example I15 | Example I6 | Example 6 | | | |
| Example I8 | Example I4 | Example 1 | 20% | 775 | 755 |
| Comparative | Comparative | Example 1 | 3% | 692 | 834 |
| Example I16 | Example I7 | | | | |
| Comparative | Comparative | Example 1 | 30% | 783 | 417 |
| Example I17 | Example I8 | | | | |
| Comparative | Comparative | Example 1 | 10% | 743 | 465 |
| Example I18 | Example I9 | | | | |

It may be learned from Table 4 that: the negative electrode plates in Examples I1 to I4 and the lithium-ion batteries in corresponding Examples 15 to 18 met characteristics described in the present disclosure, that is, energy density of each of the batteries was greater than 740 Wh/L, and a quantity of cycles of each of the batteries was greater than 750; for the negative electrode plate in Comparative Example I1 and the lithium-ion battery in Comparative Example 110, a molar ratio of O/Si of silicon oxide particles used was too high, and energy density of the battery was less than 700 Wh/L; for the negative electrode plate in Comparative Example 12 and the lithium-ion battery in Comparative Example I11, a molar ratio of O/Si of silicon oxide particles used was too low, and a quantity of cycles of the battery was less than 500; none of Dᵢ, dᵢ, (ΣEⱼ²)/(ΣDᵢ²), and (ΣFₖ²)/(ΣDᵢ²) of the negative electrode plate in Comparative Example I3 and Dᵢ′, dᵢ′, (ΣEⱼ′²)/(ΣDᵢ′²), and (ΣFₖ′²)/(ΣDᵢ′²) of the lithium-ion battery in corresponding Comparative Example I12 met requirements of the present disclosure, and a quantity of cycles of the battery was less than 600; none of (ΣEⱼ²)/(ΣDᵢ²) and (ΣFₖ′²)/(ΣDᵢ²) of the negative electrode plate in Comparative Example I14 and (ΣEⱼ′²)/(ΣDᵢ′²) and (ΣFₖ′²)/(ΣDᵢ′²) of the lithium-ion battery in corresponding Comparative Example I13 met requirements of the present disclosure, and a quantity of cycles of the battery was only about 600; none of (ΣEⱼ²)/(ΣDᵢ²), (ΣFₖ²)/(ΣDᵢ²), and (ΣFₖ′²)/S of the negative electrode plate in Comparative Example I5 and (ΣEⱼ′²)/(ΣDᵢ′²), (ΣFₖ′²)/(ΣDᵢ′²), and (ΣF_{K}′²)/S of the lithium-ion battery in corresponding Comparative Example I14 met requirements of the present disclosure, and a quantity of cycles of the battery was only about 500; neither of (ΣFₖ²)/(ΣDᵢ²) of the negative electrode plate in Comparative Example I6 and (ΣFₖ′²)/(ΣDᵢ′²) of the lithium-ion battery in corresponding Comparative Example I15 met requirements of the present disclosure, and a quantity of cycles of the battery was less than 550; neither of (ΣFₖ²)/S of the negative electrode plate in Comparative Example I7 and (ΣFₖ′²)/S of the lithium-ion battery in corresponding Comparative Example 116 met requirements of the present disclosure, and energy density of the battery was less than 700 Wh/L; neither of (ΣFₖ²)/S of the negative electrode plate in Comparative Example 18 and (ΣFₖ′²)/S of the lithium-ion battery in corresponding Comparative Example 117 met requirements of the present disclosure, and a quantity of cycles of the battery was less than 450; and neither of L of the negative electrode plate in Comparative Example 19 and L′ of the lithium-ion battery in corresponding Comparative Example 118 met requirements of the present disclosure, and a quantity of cycles of the battery was less than 500. Therefore, the battery according to the present disclosure has both characteristics of high energy density and a long cycle life.

### Example II Group

The Example II group is used to describe a negative electrode plate and a lithium-ion battery of the present disclosure that have an active material layer A containing silicon oxide particles.

### (1) The Following Gives a Method for Preparing Negative Electrode Plates in Examples II1 to II3 and Comparative Examples II1 to II8.

Silicon oxide particles, graphite having Dᵥ50 of 15 μm, sodium carboxymethyl cellulose (CMC-Na), styrene-butadiene rubber (SBR), carbon black (Super P), and single-walled carbon nanotubes (SWCNTs) were mixed in a mass ratio of y:(95-y):1.5:2.5:0.85:0.15, and deionized water was added. A resulting mixture was stirred under action of a vacuum mixer to obtain a negative electrode slurry A.

Graphite having Dᵥ50 of 15 μm, sodium carboxymethyl cellulose (CMC-Na), styrene-butadiene rubber (SBR), and carbon black (Super P) were mixed in a mass ratio of 96.4:1.3:1.7:0.6, and deionized water was added. A resulting mixture was stirred under action of a vacuum mixer to obtain a negative electrode slurry B.

The negative electrode slurry A was evenly applied on copper foil having a thickness of 6 μm at a surface density of 5 mg/cm². The copper foil was baked at 80° C. Then, the negative electrode slurry B was evenly applied on the copper foil at a surface density of 4 mg/cm². The copper foil was baked at 80° C., and then transferred to a vacuum oven for drying at 100° C. for 12 hours, followed by rolling at a press density of 1.6 g/cm³ and cutting, to obtain a negative electrode plate. FIG. 6 is a schematic cross-sectional diagram of an example of a negative electrode plate having an active material layer A that contains silicon-based material particles. Herein, 11 represents silicon-based material particles, 12 represents an active material layer, 13 represents a current collector, L_{A} represents a thickness of the active material layer A, and L_{B} represents a thickness of an active material layer B.

Comparative Example II9 and Comparative Example II10 also used the foregoing method, and a difference lay in that in Comparative Example I19, a surface density of the active material layer A was 8.5 mg/cm², while in Comparative Example II10, a surface density of the active material layer B was 8 mg/cm².

An active material layer in Comparative Example II11 is a uniform component, and a preparation method thereof is as follows.

Silicon oxide particles, graphite having Dᵥ50 of 15 μm, sodium carboxymethyl cellulose (CMC-Na), styrene-butadiene rubber (SBR), carbon black (Super P), and single-walled carbon nanotubes (SWCNTs) were mixed in a mass ratio of 9.5:85.5:1.5:2.5:0.85:0.15, and deionized water was added. A resulting mixture was stirred under action of a vacuum mixer to obtain a negative electrode slurry.

The negative electrode slurry was evenly applied on copper foil having a thickness of 6 μm at a surface density of 9 mg/cm². The copper foil was baked at 80° C., and then transferred to a vacuum oven for drying at 100° C. for 12 hours, followed by rolling at a press density of 1.6 g/cm³ and cutting, to obtain a negative electrode plate.

Table 5 gives preparation conditions of negative electrode plates in Examples II1 to II3 and Comparative Examples II1 to II11, including silicon oxide particles used and mixing amounts thereof in the active material layer A, where a mass proportion of the silicon oxide particles (namely, a ratio of a weight of the silicon oxide particles to a sum of the weight of the silicon oxide particles and a weight of graphite) is obtained by Formula y/95. Table 5 further gives physical property parameters of the negative electrode plate, including a thickness L_{A} of the active material layer A, a thickness L_{B} of the active material layer B, a maximum value of a diameter Dᵢ of a circumscribed circle, a maximum value of a diameter dᵢ of an inscribed circle, (ΣEⱼ²)/(ΣDᵢ²), (ΣFₖ²)/(ΣDᵢ²), and (ΣFₖ²)/S.

TABLE 5

| | | | | | Maximum | Maximum | | | |
|---|---|---|---|---|---|---|---|---|---|
| | Silicon | | | | value | value | | | |
| | oxide | Mass | L_{A} | L_{B} | of Dᵢ | of dᵢ | (ΣEⱼ²)/ | (ΣFₖ²)/ | (ΣFₖ²)/ |
| | particles | proportion | (μm) | (μm) | (μm) | (μm) | (ΣDᵢ²) | (ΣDᵢ²) | S |
| Example II1 | Example 1 | 18% | 37 | 28 | 26 | 20 | 0.60 | 0.65 | 0.19 |
| Example II2 | Example 2 | 18% | 37 | 28 | 27 | 19 | 0.61 | 0.65 | 0.19 |
| Example II3 | Example 3 | 18% | 38 | 27 | 33 | 23 | 0.69 | 0.77 | 0.23 |
| Comparative | Comparative | 18% | 37 | 28 | 27 | 19 | 0.59 | 0.66 | 0.18 |
| Example II1 | Example 1 | | | | | | | | |
| Comparative | Comparative | 18% | 37 | 28 | 26 | 18 | 0.61 | 0.64 | 0.19 |
| Example II2 | Example 2 | | | | | | | | |
| Comparative | Comparative | 18% | 38 | 27 | 40 | 29 | 0.80 | 0.36 | 0.25 |
| Example II3 | Example 3 | | | | | | | | |
| Comparative | Comparative | 18% | 37 | 28 | 19 | 12 | 0.20 | 0.29 | 0.09 |
| Example II4 | Example 4 | | | | | | | | |
| Comparative | Comparative | 18% | 37 | 28 | 14 | 7 | 0.08 | 0.07 | 0.03 |
| Example II5 | Example 5 | | | | | | | | |
| Comparative | Comparative | 18% | 37 | 28 | 33 | 21 | 0.74 | 0.34 | 0.31 |
| Example II6 | Example 6 | | | | | | | | |
| Comparative | Example 1 | 3.6% | 37 | 28 | 24 | 18 | 0.57 | 0.64 | 0.04 |
| Example II7 | | | | | | | | | |
| Comparative | Example 1 | 27% | 38 | 27 | 28 | 21 | 0.63 | 0.67 | 0.51 |
| Example II8 | | | | | | | | | |
| Comparative | Example 1 | 18% | 63 | 28 | 27 | 21 | 0.62 | 0.66 | 0.19 |
| Example II9 | | | | | | | | | |
| Comparative | Example 1 | 18% | 37 | 55 | 26 | 19 | 0.60 | 0.64 | 0.19 |
| Example II10 | | | | | | | | | |
| Comparative | Example 1 | 10% | 65 | \ | 26 | 20 | 0.60 | 0.65 | 0.10 |
| Example II11 | | | | | | | | | |

The negative electrode plates in Examples II1 to II3 all met requirements of the present disclosure.

Example II1 was a reference group. Example II2 differed from Example II1 only in that the silicon oxide particles used in Example II2 had a lower molar ratio of O/Si. Example II3 differed from Example II1 in that the silicon oxide particles used in Example II3 had lower secondary vibrational frequency during synthesis, and therefore had larger Dᵥmax and Dᵥ50, a higher proportion of large-size particles, and larger corresponding (ΣEⱼ²)/(ΣDᵢ²) and (ΣFₖ²)/(ΣDᵢ²).

The negative electrode plates in Comparative Examples II1 to II11 could not fully meet requirements of the present disclosure (these characteristics were indicated in bold italics in Table 5), where the molar ratio of O/Si of the silicon oxide particles in Comparative Example II1 was greater than 1.4; the molar ratio of O/Si of the silicon oxide particles in Comparative Example II2 was less than 0.7; for the negative electrode plate in Comparative Example II3, a maximum value of Dᵢ was greater than 35 μm, a maximum value of dᵢ was greater than 25 μm, (ΣEⱼ²)/(ΣDᵢ²) was greater than 0.75, and (ΣFₖ²)/(ΣDᵢ²) was less than 0.37, and it is learned from comparison and analysis that the vibrational frequency was too low during the secondary pulverization of the silicon oxide particles used in the negative electrode plate, and therefore, corners of the particles were not fully rounded off, thus exhibiting a larger diameter of circumscribed circle, which also makes the value of (ΣFₖ²)/(ΣDᵢ²) relatively reduced; for the negative electrode plate in Comparative Example II4, (ΣEⱼ²)/(ΣDᵢ²) was less than 0.45 and (ΣFₖ²)/(ΣDᵢ²) was less than 0.37, the vibrational frequency was too high during the secondary pulverization of the silicon oxide particles used in the negative electrode plate, the particle size is further refined, and as a result, parameters related to a circumscribed circle and an inscribed circle could not meet the requirements; for the negative electrode plate in Comparative Example II5, (ΣEⱼ²)/(ΣDᵢ²) and (ΣFₖ²)/(ΣDᵢ²) were lower than those in Comparative Example II4, this was because the vibrational frequency of the container was too high during the secondary pulverization of the silicon oxide particles used in the negative electrode plate, resulting in the particle size of the silicon oxide particles being smaller; for the negative electrode plate in Comparative Example II6, (ΣFₖ²)/(ΣDᵢ²) was less than 0.37, this was because only primary pulverization was used for the silicon oxide particles used in the negative electrode plate for particle size refinement and the rotational frequency of the container was too high during the pulverization, and as a result, the particles retained more corners; for the negative electrode plate in Comparative Example II7, (ΣFₖ²)/S was too low, and the mixing amount of the silicon oxide particles was too small; for the negative electrode plate in Comparative Example II8, (ΣFₖ²)/S was too high, and the mixing amount of the silicon oxide particles was too large; the thickness of the active material layer A in Comparative Example I19 was greater than 60 μm; the thickness of the active material layer B in Comparative Example II10 was greater than 50 μm; and the thickness of the active material layer B in Comparative Example II11 was less than 20 μm.

### (2) Method for Preparing a Lithium-Ion Battery

Silicon oxide particles, graphite having Dᵥ50 of 15 μm, sodium carboxymethyl cellulose (CMC-Na), styrene-butadiene rubber (SBR), carbon black (Super P), and single-walled carbon nanotubes (SWCNTs) were mixed in a mass ratio of y:(95-y):1.5:2.5:0.85:0.15, and deionized water was added. A resulting mixture was stirred under action of a vacuum mixer to obtain a negative electrode slurry A.

Graphite having Dᵥ50 of 15 μm, sodium carboxymethyl cellulose (CMC-Na), styrene-butadiene rubber (SBR), and carbon black (Super P) were mixed in a mass ratio of 96.4:1.3:1.7:0.6, and deionized water was added. A resulting mixture was stirred under action of a vacuum mixer to obtain a negative electrode slurry B.

The negative electrode slurry A was evenly applied on copper foil having a thickness of 6 μm. The copper foil was baked at 80° C. Then, the negative electrode slurry B was evenly applied on the copper foil. The copper foil was baked at 80° C., and then transferred to a vacuum oven for drying at 100° C. for 12 hours, followed by rolling and cutting, to obtain a negative electrode plate.

Lithium cobalt oxide (LCO), polyvinylidene fluoride (PVDF), and carbon black (Super P) were mixed in a mass ratio of 96:2:2, and N-methylpyrrolidone (NMP) was added. A resulting mixture was stirred under action of a vacuum mixer until a uniform positive electrode slurry was formed. The positive electrode slurry was evenly applied on aluminum foil having a thickness of 12 μm. The coated aluminum foil was baked in an oven, and then transferred to an oven for drying at 120° C. for 8 hours, followed by rolling at a press density of 4.0 g/cm³ and cutting, to obtain a required positive electrode plate. A size of the positive electrode plate was less than that of the negative electrode plate to avoid lithium deposition at an edge of the negative electrode plate. An initial lithium deintercalation capacity per unit area of the positive electrode plate was 2% lower than initial lithium intercalation capacity per unit area of the negative electrode plate, to ensure that the negative electrode plate had sufficient lithium storage sites to avoid lithium deposition on the negative electrode plate.

In an inert gas atmosphere, a mixed solution was prepared in a mass ratio of EC:PC:PP:LiPF₆:FEC:PS=13:13:50:15:5:4, and the mixed solution was stirred evenly to obtain a required electrolyte solution.

A polyethylene separator having a thickness of 8 μm was used.

A layer of lithium foil was attached to the surface of the negative electrode plate by a roll-pressing method to obtain a pre-lithiated negative electrode plate, so that initial efficiency of the pre-lithiated negative electrode plate in the button battery test ranged from 91.5% to 92.3%.

The positive electrode plate, the separator, and the negative electrode plate prepared above were sequentially stacked to ensure that the separator was located between the positive electrode plate and the negative electrode plate for separation, and then winding was performed to obtain a bare cell without liquid injection. The bare cell was placed in an aluminum-plastic film housing, the prepared electrolyte solution was injected into the dried bare cell, and after processes such as vacuum packaging, standing, forming, shaping, and sorting, the lithium-ion battery required was obtained.

Preparation of the pre-lithiated negative electrode plate used striped lithium foil having a thickness of 5 μm, where lithium foil sections and blank sections were alternately and repeatedly distributed. Widths of the lithium foil sections and blank sections in Examples and Comparative Examples were as follows. In Example II4, Example II6, Comparative Examples II14 to II17, and Comparative Example II22, a width of a lithium foil section was 0.25 cm, and a width of a blank section was 0.75 cm; in Example II5 and Comparative Example II21, a width of a lithium foil section was 0.2 cm, and a width of a blank section was 0.8 cm; in Comparative Example II12, a width of a lithium foil section was 0.33 cm, and a width of a blank section was 0.67 cm; in Comparative Example II13, a width of a lithium foil section was 0.15 cm, and a width of a blank section was 0.85 cm; in Comparative Example II18, no lithium pre-lithiation was involved; in Comparative Example II19, a width of a lithium foil section was 0.4 cm, and a width of a blank section was 0.6 cm; and in Comparative Example II20, a width of a lithium foil section was 0.45 cm, and a width of a blank section was 0.55 cm.

Two charge-discharge cycles were performed according to the foregoing cycle system, and the battery was disassembled to obtain a negative electrode plate.

Table 6 gives physical property parameters of the negative electrode plates after the two cycles were performed for the lithium-ion batteries in Examples II4 to II6 and Comparative Examples II12 to I22, including a thickness L_{A}′ of the active material layer A, a thickness L_{B}′ of the active material layer B, a maximum value of a diameter Dᵢ′ of a circumscribed circle, a maximum value of a diameter dᵢ′ of an inscribed circle, (ΣEⱼ′²)/(ΣDᵢ′²), (ΣFₖ′²)/(ΣDᵢ′²), and (ΣFₖ′²)/S.

TABLE 6

| | | | | | | Maximum | Maximum | | | |
|---|---|---|---|---|---|---|---|---|---|---|
| | Negative | Silicon | | | | value | value | | | |
| | electrode | oxide | Mass | L_{A}′ | L_{B}′ | of Dᵢ′ | of dᵢ′ | (ΣEⱼ′²)/ | (ΣFₖ′²)/ | (ΣFₖ′²)/ |
| | plate | particles | proportion | (μm) | (μm) | (μm) | (μm) | (ΣDᵢ′²) | (ΣDᵢ′²) | S |
| Example II4 | Example II1 | Example 1 | 18% | 47 | 31 | 33 | 25 | 0.62 | 0.67 | 0.23 |
| Example II5 | Example II2 | Example 2 | 18% | 47 | 31 | 34 | 24 | 0.60 | 0.64 | 0.23 |
| Example II6 | Example II3 | Example 3 | 18% | 48 | 31 | 42 | 29 | 0.68 | 0.75 | 0.27 |
| Comparative | Comparative | Comparative | 18% | 48 | 31 | 33 | 23 | 0.60 | 0.65 | 0.21 |
| Example II12 | Example II1 | Example 1 | | | | | | | | |
| Comparative | Comparative | Comparative | 18% | 47 | 31 | 33 | 22 | 0.61 | 0.65 | 0.22 |
| Example II13 | Example II2 | Example 2 | | | | | | | | |
| Comparative | Comparative | Comparative | 18% | 49 | 30 | 52 | 37 | 0.83 | 0.34 | 0.30 |
| Example II14 | Example II3 | Example 3 | | | | | | | | |
| Comparative | Comparative | Comparative | 18% | 47 | 30 | 23 | 15 | 0.23 | 0.31 | 0.11 |
| Example II15 | Example II4 | Example 4 | | | | | | | | |
| Comparative | Comparative | Comparative | 18% | 47 | 30 | 17 | 10 | 0.09 | 0.08 | 0.04 |
| Example II16 | Example II5 | Example 5 | | | | | | | | |
| Comparative | Comparative | Comparative | 18% | 47 | 30 | 33 | 25 | 0.75 | 0.35 | 0.34 |
| Example II17 | Example II6 | Example 6 | | | | | | | | |
| Comparative | Comparative | Example 1 | 3.6% | 47 | 30 | 31 | 22 | 0.58 | 0.64 | 0.05 |
| Example II18 | Example II7 | | | | | | | | | |
| Comparative | Comparative | Example 1 | 27% | 50 | 30 | 34 | 26 | 0.61 | 0.66 | 0.59 |
| Example II19 | Example II8 | | | | | | | | | |
| Comparative | Comparative | Example 1 | 18% | 81 | 30 | 34 | 27 | 0.62 | 0.65 | 0.23 |
| Example II20 | Example II9 | | | | | | | | | |
| Comparative | Comparative | Example 1 | 18% | 47 | 62 | 33 | 24 | 0.63 | 0.67 | 0.22 |
| Example II21 | Example II10 | | | | | | | | | |
| Comparative | Comparative | Example 1 | 10% | 78 | \ | 33 | 25 | 0.62 | 0.67 | 0.12 |
| Example II22 | Example II11 | | | | | | | | | |

The data conclusions given in Table 6 are similar to those in Table 5 and are not repeated herein.

### Test Example II

Cycling performance tests were performed on the lithium-ion batteries obtained in the Example II group and Comparative Examples.

Test steps for the lithium-ion battery are as follows.
(1) A LAND test system was used and a test temperature was 25° C.
(2) The battery was charged to 4.45 V at a constant current of 3.0 C, to obtain a constant-current charging capacity Q_{C1}, charged to 0.2 C at a constant voltage to obtain a constant-voltage capacity Q_{C2}, left standing for 10 minutes, and then discharged to 3.0 V at 1 C to obtain an initial capacity. Q_{C1}/(Q_{C1}+Q_{C2}) was used as an initial constant-current charging ratio, and a product of the initial capacity and an average discharge voltage was used as energy of the battery.

The battery was charged to 3.82 V at a constant current of 3.0 C and charged to 0.02 C at a constant voltage. A thickness of the battery in this case was measured and used as an initial thickness of the battery. A product of the initial thickness, a length, and a width of the battery was used as an initial volume of the battery, and the energy of the battery divided by the initial volume of the battery was used as energy density of the battery.
(3) The charge-discharge step in which the battery was charged to 4.45 V at a constant current of 3.0 C, charged to 0.2 C at a constant voltage, left standing for 10 minutes, discharged to 3.0 V at 1 C, and then left standing for 10 minutes was used as a cycle and 500 cycles were performed, and a discharge capacity in the 500th cycle divided by the initial capacity was used as a capacity retention rate.
(4) The battery was charged to 4.45 V at a constant current of 3.0 C, to obtain a constant-current charging capacity Q_{C3}, charged to 0.2 C at a constant voltage to obtain a constant-voltage capacity Q_{C4}, left standing for 10 minutes, and then discharged to 3.0 V at 1 C. Q_{C3}/(Q_{C3}+Q_{C4}) was used as a final constant-current charging ratio.

Table 7 gives energy density, initial constant-current charging ratios, capacity retention rates, and final constant-current charging ratios of the lithium-ion batteries in Examples II4 to II6 and Comparative Examples II12 to II22.

TABLE 7

| | | | | | Initial | | Final |
|---|---|---|---|---|---|---|---|
| | | | | | constant- | | constant- |
| | Negative | Silicon | | Energy | current | Capacity | current |
| | electrode | oxide | Mass | density | charging | retention | charging |
| | plate | particles | proportion | (Wh/L) | ratio | rate | ratio |
| Example II4 | Example II1 | Example 1 | 18% | 722 | 66% | 84% | 42% |
| Example II5 | Example II2 | Example 2 | 18% | 741 | 67% | 81% | 39% |
| Example II6 | Example II3 | Example 3 | 18% | 721 | 67% | 83% | 40% |
| Comparative | Comparative | Comparative | 18% | 685 | 65% | 83% | 38% |
| Example II12 | Example II1 | Example 1 | | | | | |
| Comparative | Comparative | Comparative | 18% | 748 | 65% | 71% | 16% |
| Example II13 | Example II2 | Example 2 | | | | | |
| Comparative | Comparative | Comparative | 18% | 719 | 64% | 73% | 25% |
| Example II14 | Example II3 | Example 3 | | | | | |
| Comparative | Comparative | Comparative | 18% | 723 | 64% | 69% | 17% |
| Example II15 | Example II4 | Example 4 | | | | | |
| Comparative | Comparative | Comparative | 18% | 724 | 65% | 65% | 16% |
| Example II16 | Example II5 | Example 5 | | | | | |
| Comparative | Comparative | Comparative | 18% | 718 | 64% | 70% | 22% |
| Example II17 | Example II6 | Example 6 | | | | | |
| Comparative | Comparative | Example 1 | 3.6% | 675 | 56% | 75% | 21% |
| Example II18 | Example II7 | | | | | | |
| Comparative | Comparative | Example 1 | 27% | 759 | 67% | 77% | 25% |
| Example II19 | Example II8 | | | | | | |
| Comparative | Comparative | Example 1 | 18% | 713 | 57% | 76% | 22% |
| Example II20 | Example II9 | | | | | | |
| Comparative | Comparative | Example 1 | 18% | 704 | 55% | 71% | 18% |
| Example II21 | Example II10 | | | | | | |
| Comparative | Comparative | Example 1 | 10% | 696 | 54% | 72% | 15% |
| Example II22 | Example II11 | | | | | | |

It may be learned from Table 7 that: the negative electrodes in Examples II1 to II3 and the lithium-ion batteries in corresponding Examples II4 to II6 met characteristics described in the present disclosure, that is, energy density of a battery was greater than 700 Wh/L, an initial constant-current charging ratio was greater than 60%, a cycling capacity retention rate was greater than 80%, and a final constant-current charging ratio was greater than 30%; for the negative electrode plate in Comparative Example II1 and the lithium-ion battery in Comparative Example II12, a molar ratio of O/Si of silicon oxide particles used was too high, and energy density of the battery was less than 700 Wh/L; for the negative electrode plate in Comparative Example II2 and the lithium-ion battery in Comparative Example II13, a molar ratio of O/Si of silicon oxide particles used was too low, a cycling capacity retention rate was less than 80%, and a final constant-current charging ratio was less than 30%; none of Dᵢ, dᵢ, (ΣEⱼ²)/(ΣDᵢ²), and (ΣFₖ²)/(ΣDᵢ²) of the negative electrode plate in Comparative Example II3 and Dᵢ′, dᵢ′, (ΣEⱼ′²)/(ΣDᵢ′²), and (ΣFₖ′²)/(ΣDᵢ′²) of the lithium-ion battery in Comparative Example II14 met requirements of the present disclosure, a cycling capacity retention rate was less than 80%, and a final constant-current charging ratio was less than 30%; none of (ΣEⱼ²)/(ΣDᵢ²) and (ΣFₖ²)/(ΣDᵢ²) of the negative electrode plate in Comparative Example II4 and (ΣEⱼ′²)/(ΣDᵢ′²) and (ΣFₖ′²)/(ΣDᵢ′²) of the lithium-ion battery in Comparative Example II15 met requirements of the present disclosure, a cycling capacity retention rate was less than 80%, and a final constant-current charging ratio was less than 30%; none of (ΣEⱼ²)/(ΣDᵢ²), (ΣFₖ²)/(ΣDᵢ²), and (ΣFₖ²)/S of the negative electrode plate in Comparative Example II5 and (ΣEⱼ′²)/(ΣDᵢ′²), (ΣFₖ′²)/(ΣDᵢ′²), and (ΣFₖ′²)/S of the lithium-ion battery in Comparative Example II16 met requirements of the present disclosure, a cycling capacity retention rate was less than 80%, and a final constant-current charging ratio was less than 30%; neither of (ΣF_{K}²)/(ΣDᵢ²) of the negative electrode plate in Comparative Example II6 and (ΣFₖ′²)/(ΣDᵢ′²) of the lithium-ion battery in Comparative Example II17 met requirements of the present disclosure, a cycling capacity retention rate was less than 80%, and a final constant-current charging ratio was less than 30%; neither of (ΣFₖ²)/S of the negative electrode plate in Comparative Example II7 and (ΣFₖ′²)/S of the lithium-ion battery in Comparative Example II18 met requirements of the present disclosure, energy density of the battery was less than 700 Wh/L, an initial constant-current charging ratio was less than 60%, a cycling capacity retention rate was less than 80%, and a final constant-current charging ratio was less than 30%; neither of (ΣFₖ²)/S of the negative electrode plate in Comparative Example II8 and (ΣFₖ′²)/S of the lithium-ion battery in Comparative Example II19 met requirements of the present disclosure, a cycling capacity retention rate was less than 80%, and a final constant-current charging ratio was less than 30%; neither of L_{A} of the negative electrode plate in Comparative Example 119 and L_{A}′ of the lithium-ion battery in Comparative Example II20 met requirements of the present disclosure, an initial constant-current charging ratio was less than 60%, a cycling capacity retention rate was less than 80%, and a final constant-current charging ratio was less than 30%; neither of L_{B} of the negative electrode plate in Comparative Example II10 and L_{B}′ of the lithium-ion battery in Comparative Example II21 met requirements of the present disclosure, an initial constant-current charging ratio was less than 60%, a cycling capacity retention rate was less than 80%, and a final constant-current charging ratio was less than 30%; and silicon oxide particles of the negative electrode plate were uniformly distributed in the active material layer in Comparative Example II11 and Comparative Example II22, which did not meet requirements of the present disclosure, energy density of the battery was less than 700 Wh/L, an initial constant-current charging ratio was less than 60%, a cycling capacity retention rate was less than 80%, and a final constant-current charging ratio was less than 30%.

### Example III Group

The Example III group is used to describe a negative electrode plate and a lithium-ion battery of the present disclosure that have an active material layer A that does not contain silicon oxide particles.

### (1) The Following Gives a Method for Preparing Negative Electrode PLATES in Examples III1 to III3 and Comparative Examples III1 to III8.

Graphite having Dᵥ50 of 15 μm, sodium carboxymethyl cellulose (CMC-Na), styrene-butadiene rubber (SBR), and carbon black (Super P) were mixed in a mass ratio of 96.4:1.3:1.7:0.6, and deionized water was added. A resulting mixture was stirred under action of a vacuum mixer to obtain a negative electrode slurry A.

Silicon oxide particles, graphite having Dᵥ50 of 15 μm, sodium carboxymethyl cellulose (CMC-Na), styrene-butadiene rubber (SBR), carbon black (Super P), and single-walled carbon nanotubes (SWCNTs) were mixed in a mass ratio of y:(95-y):1.5:2.5:0.85:0.15, and deionized water was added. A resulting mixture was stirred under action of a vacuum mixer to obtain a negative electrode slurry B.

The negative electrode slurry A was evenly applied on copper foil having a thickness of 6 μm at a surface density of 3 mg/cm². The copper foil was baked at 80° C. Then, the negative electrode slurry B was evenly applied on the copper foil at a surface density of 5 mg/cm². The copper foil was baked at 80° C., and then transferred to a vacuum oven for drying at 100° C. for 12 hours, followed by rolling at a press density of 1.6 g/cm³ and cutting, to obtain a negative electrode plate.

Comparative Example III9 and Comparative Example III10 also used the foregoing method, and a difference lay in that in Comparative Example III9, a surface density of the active material layer A was 6 mg/cm², while in Comparative Example III10, a surface density of the active material layer B was 8 mg/cm². FIG. 7 is a schematic cross-sectional diagram of an example of a negative electrode plate having an active material layer A that does not contain silicon-based material particles. Herein, 11 represents silicon-based material particles, 12 represents an active material layer, 13 represents a current collector, L_{A} represents a thickness of the active material layer A, and L_{B} represents a thickness of an active material layer B.

An active material layer in Comparative Example III11 is a uniform component, and a preparation method thereof is as follows.

Silicon oxide particles, graphite having Dᵥ50 of 15 μm, sodium carboxymethyl cellulose (CMC-Na), styrene-butadiene rubber (SBR), carbon black (Super P), and single-walled carbon nanotubes (SWCNTs) were mixed in a mass ratio of 9.5:85.5:1.5:2.5:0.85:0.15, and deionized water was added. A resulting mixture was stirred under action of a vacuum mixer to obtain a negative electrode slurry.

The negative electrode slurry was evenly applied on copper foil having a thickness of 6 μm at a surface density of 8 mg/cm². The copper foil was baked at 80° C., and then transferred to a vacuum oven for drying at 100° C. for 12 hours, followed by rolling at a press density of 1.6 g/cm³ and cutting, to obtain a negative electrode plate.

Table 8 gives preparation conditions of negative electrode plates in Examples III1 to III3 and Comparative Examples III1 to III11, including silicon oxide particles used and mixing amounts thereof in the active material layer B, where a mass proportion of the silicon oxide particles (namely, a ratio of a weight of the silicon oxide particles to a sum of the weight of the silicon oxide particles and a weight of graphite) is obtained by Formula y/95. Table 8 further gives physical property parameters of the negative electrode plate, including a thickness L_{A} of the active material layer A, a thickness L_{B} of the active material layer B, a maximum value of a diameter Dᵢ of a circumscribed circle, a maximum value of a diameter dᵢ of an inscribed circle, (ΣEⱼ²)/(ΣDᵢ²), (ΣFₖ²)/(ΣDᵢ²), and (ΣFₖ²)/S.

TABLE 8

| | | | | | Maximum | Maximum | | | |
|---|---|---|---|---|---|---|---|---|---|
| | Silicon | | | | value | value | | | |
| | oxide | Mass | L_{A} | L_{B} | of Dᵢ | of dᵢ | (ΣEⱼ²)/ | (ΣFₖ²)/ | (ΣFₖ²)/ |
| | particles | proportion | (μm) | (μm) | (μm) | (μm) | (ΣDᵢ²) | (ΣDᵢ²) | S |
| Example III1 | Example 1 | 16% | 23 | 37 | 27 | 21 | 0.62 | 0.68 | 0.17 |
| Example III2 | Example 2 | 16% | 23 | 37 | 26 | 20 | 0.59 | 0.64 | 0.17 |
| Example III3 | Example 3 | 16% | 22 | 38 | 34 | 20 | 0.71 | 0.76 | 0.20 |
| Comparative | Comparative | 16% | 23 | 37 | 26 | 21 | 0.61 | 0.64 | 0.15 |
| Example III1 | Example 1 | | | | | | | | |
| Comparative | Comparative | 16% | 23 | 37 | 27 | 19 | 0.59 | 0.67 | 0.17 |
| Example III2 | Example 2 | | | | | | | | |
| Comparative | Comparative | 16% | 22 | 38 | 41 | 30 | 0.78 | 0.33 | 0.22 |
| Example III3 | Example 3 | | | | | | | | |
| Comparative | Comparative | 16% | 23 | 37 | 18 | 11 | 0.23 | 0.28 | 0.08 |
| Example III4 | Example 4 | | | | | | | | |
| Comparative | Comparative | 16% | 23 | 37 | 15 | 8 | 0.09 | 0.07 | 0.03 |
| Example III5 | Example 5 | | | | | | | | |
| Comparative | Comparative | 16% | 23 | 37 | 34 | 21 | 0.73 | 0.33 | 0.32 |
| Example III6 | Example 6 | | | | | | | | |
| Comparative | Example 1 | 3.2% | 23 | 37 | 25 | 19 | 0.61 | 0.63 | 0.04 |
| Example III7 | | | | | | | | | |
| Comparative | Example 1 | 32% | 22 | 38 | 27 | 19 | 0.60 | 0.65 | 0.49 |
| Example III8 | | | | | | | | | |
| Comparative | Example 1 | 16% | 44 | 37 | 26 | 22 | 0.59 | 0.68 | 0.16 |
| Example III9 | | | | | | | | | |
| Comparative | Example 1 | 16% | 22 | 61 | 27 | 21 | 0.58 | 0.67 | 0.17 |
| Example III10 | | | | | | | | | |
| Comparative | Example 1 | 10% | \ | 60 | 27 | 21 | 0.62 | 0.68 | 0.09 |
| Example III11 | | | | | | | | | |

The negative electrode plates in Examples III1 to III3 all met requirements of the present disclosure.

Example III1 was a reference group. Example III2 differed from Example III1 only in that the silicon oxide particles used in Example III2 had a lower molar ratio of O/Si. Example III3 differed from Example III1 in that the silicon oxide particles used in Example III3 had lower secondary vibrational frequency during synthesis, and therefore had larger Dᵥmax and Dᵥ50, a higher proportion of large-size particles, and larger corresponding (ΣEⱼ²)/(ΣDᵢ²) and (ΣFₖ²)/(ΣDᵢ²).

The negative electrode plates in Comparative Examples III1 to III11 could not fully meet requirements of the present disclosure, and these characteristics were indicated in bold italics in the table, where the molar ratio of O/Si of the silicon oxide particles in Comparative Example III1 was greater than 1.4; the molar ratio of O/Si of the silicon oxide particles in Comparative Example III2 was less than 0.7; for the negative electrode plate in Comparative Example III3, a maximum value of D; was greater than 35 μm, a maximum value of d; was greater than 25 μm, (ΣEⱼ²)/(ΣDᵢ²) was greater than 0.75, and (ΣFₖ²)/(ΣDᵢ²) was less than 0.37, and it is learned from comparison and analysis that the vibrational frequency was too low during the secondary pulverization of the silicon oxide particles used in the negative electrode plate, and therefore, corners of the particles were not fully rounded off, thus exhibiting a larger diameter of circumscribed circle, which also makes the value of (ΣFₖ²)/(ΣDᵢ²) relatively reduced; for the negative electrode plate in Comparative Example III4, (ΣEⱼ²)/(ΣDᵢ²) was less than 0.45 and (ΣFₖ²)/(ΣDᵢ²) was less than 0.37, the vibrational frequency was too high during the secondary pulverization of the silicon oxide particles used in the negative electrode plate, the particle size is further refined, and as a result, parameters related to a circumscribed circle and an inscribed circle could not meet the requirements; for the negative electrode plate in Comparative Example III5, (ΣEⱼ²)/(ΣDᵢ²) and (ΣFₖ²)/(ΣDᵢ²) were lower than those in Comparative Example III4, this was because the vibrational frequency of the container was too high during the secondary pulverization of the silicon oxide particles used in the negative electrode plate, resulting in the particle size of the silicon oxide particles being smaller; for the negative electrode plate in Comparative Example III6, (ΣFₖ²)/(ΣDᵢ²) was less than 0.37, this was because only primary pulverization was used for the silicon oxide particles used in the negative electrode plate for particle size refinement and the rotational frequency of the container was too high during the pulverization, and as a result, the particles retained more corners; for the negative electrode plate in Comparative Example III7, (ΣFₖ²)/S was too low, and the mixing amount of the silicon oxide particles was too small; for the negative electrode plate in Comparative Example III8, (ΣFₖ²)/S was too high, and the mixing amount of the silicon oxide particles was too large; the thickness of the active material layer A in Comparative Example III9 was greater than 40 μm; the thickness of the active material layer B in Comparative Example III10 was greater than 60 μm; and the thickness of the active material layer A in Comparative Example III11 was less than 20 μm.

### (2) Method for Preparing a Lithium-Ion Battery

Graphite having Dᵥ50 of 15 μm, sodium carboxymethyl cellulose (CMC-Na), styrene-butadiene rubber (SBR), and carbon black (Super P) were mixed in a mass ratio of 96.4:1.3:1.7:0.6, and deionized water was added. A resulting mixture was stirred under action of a vacuum mixer to obtain a negative electrode slurry A.

Silicon oxide particles, graphite having Dᵥ50 of 15 μm, sodium carboxymethyl cellulose (CMC-Na), styrene-butadiene rubber (SBR), carbon black (Super P), and single-walled carbon nanotubes (SWCNTs) were mixed in a mass ratio of y:(95-y):1.5:2.5:0.85:0.15, and deionized water was added. A resulting mixture was stirred under action of a vacuum mixer to obtain a negative electrode slurry B.

The negative electrode slurry A was evenly applied on copper foil having a thickness of 6 μm. The copper foil was baked at 80° C. Then, the negative electrode slurry B was evenly applied on the copper foil. The copper foil was baked at 80° C., and then transferred to a vacuum oven for drying at 100° C. for 12 hours, followed by rolling and cutting, to obtain a negative electrode plate.

Lithium cobalt oxide (LCO), polyvinylidene fluoride (PVDF), and carbon black (Super P) were mixed in a mass ratio of 96:2:2, and N-methylpyrrolidone (NMP) was added. A resulting mixture was stirred under action of a vacuum mixer until a uniform positive electrode slurry was formed. The positive electrode slurry was evenly applied on aluminum foil having a thickness of 12 μm. The coated aluminum foil was baked in an oven, and then transferred to an oven for drying at 120° C. for 8 hours, followed by rolling at a press density of 4.0 g/cm³ and cutting, to obtain a required positive electrode plate. A size of the positive electrode plate was less than that of the negative electrode plate to avoid lithium deposition at an edge of the negative electrode plate. An initial lithium deintercalation capacity per unit area of the positive electrode plate was 2% lower than initial lithium intercalation capacity per unit area of the negative electrode plate, to ensure that the negative electrode plate had sufficient lithium storage sites to avoid lithium deposition on the negative electrode plate.

In an inert gas atmosphere, a mixed solution was prepared in a mass ratio of EC:PC:PP:LiPF₆:FEC:PS=13:13:50:15:5:4, and the mixed solution was stirred evenly to obtain a required electrolyte solution.

A polyethylene separator having a thickness of 8 μm was used.

A layer of lithium foil was attached to the surface of the negative electrode plate by a roll-pressing method to obtain a pre-lithiated negative electrode plate, so that initial efficiency of the pre-lithiated negative electrode plate in the button battery test ranged from 91.3% to 92.3%.

The positive electrode plate, the separator, and the negative electrode plate prepared above were sequentially stacked to ensure that the separator was located between the positive electrode plate and the negative electrode plate for separation, and then winding was performed to obtain a bare cell without liquid injection. The bare cell was placed in an aluminum-plastic film housing, the prepared electrolyte solution was injected into the dried bare cell, and after processes such as vacuum packaging, standing, forming, shaping, and sorting, the lithium-ion battery required was obtained.

Preparation of the pre-lithiated negative electrode plate used striped lithium foil having a thickness of 5 μm, where lithium foil sections and blank sections were alternately and repeatedly distributed. Widths of the lithium foil sections and blank sections in Examples and Comparative Examples were as follows. In Example III4, Example III6, Comparative Examples III14 to III17, and Comparative Example III20, a width of a lithium foil section was 0.25 cm, and a width of a blank section was 0.75 cm; in Example III5 and Comparative Example III22, a width of a lithium foil section was 0.2 cm, and a width of a blank section was 0.8 cm; in Comparative Example III12, a width of a lithium foil section was 0.33 cm, and a width of a blank section was 0.67 cm; in Comparative Example III13, a width of a lithium foil section was 0.15 cm, and a width of a blank section was 0.85 cm; in Comparative Example III18, no lithium pre-lithiation was involved; and in Comparative Example III19 and Comparative Example III21, a width of a lithium foil section was 0.4 cm, and a width of a blank section was 0.6 cm.

Two charge-discharge cycles were performed according to the foregoing cycle system, and the battery was disassembled to obtain a negative electrode plate.

Table 9 gives physical property parameters of the negative electrode plates after the two cycles were performed for the lithium-ion batteries in Examples III4 to III6 and Comparative Examples III12 to III22, including a thickness L_{A}′ of the active material layer A, a thickness L_{B}′ of the active material layer B, a maximum value of a diameter Dᵢ′ of a circumscribed circle, a maximum value of a diameter dᵢ′ of an inscribed circle, (ΣEⱼ′²)/(ΣDᵢ′²), (ΣFₖ′²)/(ΣDᵢ′²), and (ΣFₖ′²)/S.

TABLE 9

| | | | | | | Maximum | Maximum | | | |
|---|---|---|---|---|---|---|---|---|---|---|
| | Negative | Silicon | | | | value | value | | | |
| | electrode | oxide | Mass | L_{A}′ | L_{B}′ | of Dᵢ′ | of dᵢ′ | (ΣEⱼ′²)/ | (ΣFₖ′²)/ | (ΣFₖ′²)/ |
| | plate | particles | proportion | (μm) | (μm) | (μm) | (μm) | (ΣDᵢ′²) | (ΣDᵢ′²) | S |
| Example III4 | Example III1 | Example 1 | 16% | 25 | 47 | 34 | 25 | 0.63 | 0.69 | 0.22 |
| Example III5 | Example III2 | Example 2 | 16% | 25 | 48 | 32 | 24 | 0.61 | 0.66 | 0.23 |
| Example III6 | Example III3 | Example 3 | 16% | 24 | 47 | 40 | 30 | 0.69 | 0.77 | 0.26 |
| Comparative | Comparative | Comparative | 16% | 25 | 47 | 32 | 23 | 0.63 | 0.66 | 0.19 |
| Example III12 | Example III1 | Example 1 | | | | | | | | |
| Comparative | Comparative | Comparative | 16% | 25 | 48 | 33 | 22 | 0.64 | 0.65 | 0.23 |
| Example III13 | Example III2 | Example 2 | | | | | | | | |
| Comparative | Comparative | Comparative | 16% | 24 | 49 | 49 | 38 | 0.81 | 0.31 | 0.29 |
| Example III14 | Example III3 | Example 3 | | | | | | | | |
| Comparative | Comparative | Comparative | 16% | 25 | 47 | 22 | 16 | 0.21 | 0.26 | 0.11 |
| Example III15 | Example III4 | Example 4 | | | | | | | | |
| Comparative | Comparative | Comparative | 16% | 25 | 47 | 18 | 11 | 0.10 | 0.09 | 0.05 |
| Example III16 | Example III5 | Example 5 | | | | | | | | |
| Comparative | Comparative | Comparative | 16% | 25 | 47 | 34 | 26 | 0.75 | 0.34 | 0.36 |
| Example III17 | Example III6 | Example 6 | | | | | | | | |
| Comparative | Comparative | Example 1 | 3.2% | 25 | 48 | 33 | 20 | 0.59 | 0.65 | 0.05 |
| Example III18 | Example III7 | | | | | | | | | |
| Comparative | Comparative | Example 1 | 32% | 24 | 49 | 32 | 24 | 0.63 | 0.64 | 0.58 |
| Example III19 | Example III8 | | | | | | | | | |
| Comparative | Comparative | Example 1 | 16% | 48 | 48 | 31 | 25 | 0.58 | 0.66 | 0.24 |
| Example III20 | Example III9 | | | | | | | | | |
| Comparative | Comparative | Example 1 | 16% | 24 | 79 | 34 | 23 | 0.63 | 0.68 | 0.23 |
| Example III21 | Example III10 | | | | | | | | | |
| Comparative | Comparative | Example 1 | 10% | \ | 72 | 34 | 25 | 0.63 | 0.69 | 0.11 |
| Example III22 | Example III11 | | | | | | | | | |

The data conclusions given in Table 9 are similar to those in Table 8 and are not repeated herein.

### Test Example III

Cycling performance tests were performed on the lithium-ion batteries obtained in the Example III group and Comparative Examples.

Test steps for the lithium-ion battery are as follows.
(1) A LAND test system was used and a test temperature was 25° C.
(2) The battery was charged to 4.45 V at a constant current of 2.0 C, charged to 0.2 C at a constant voltage, left standing for 10 minutes, and then discharged to 3.0 V at 1 C to obtain an initial capacity. A product of the initial capacity and an average discharge voltage was used as energy of the battery.

The battery was charged to 3.82 V at a constant current of 2.0 C and charged to 0.02 C at a constant voltage. A thickness of the battery in this case was measured and used as an initial thickness of the battery. A product of the initial thickness, a length, and a width of the battery was used as an initial volume of the battery, and the energy of the battery divided by the initial volume of the battery was used as energy density of the battery.
(3) The charge-discharge step in which the battery was charged at a constant current of 8.0 C for 2 minutes and left standing for 10 minutes, charged at a constant current of 5.0 C for 3 minutes and left standing for 10 minutes, charged at a constant current of 2.0 C for 5 minutes and left standing for 10 minutes, and then discharged to 3.0 V at 1 C and left standing for 10 minutes was used as a cycle and 300 cycles were performed, and a discharge capacity in the 300th cycle divided by the initial capacity was used as a capacity retention rate.
(4) The battery was charged at a constant current of 8.0 C for 2 minutes and left standing for 10 minutes, charged at a constant current of 5.0 C for 3 minutes and left standing for 10 minutes, and charged at a constant current of 2.0 C for 5 minutes, and the battery was disassembled to observe a degree of lithium deposition on a surface of the negative electrode plate.

Table 10 gives energy density, initial constant-current charging ratios, capacity retention rates, and degrees of lithium deposition of the lithium-ion batteries in Examples III4 to III6 and Comparative Examples III12 to III22. When a lithium deposition area on the surface of the negative electrode plate accounted for less than 5% of a total area of the negative electrode plate, the degree of lithium deposition was low; when the lithium deposition area on the surface of the negative electrode plate accounted for 5% to 20% of the total area of the negative electrode plate, the degree of lithium deposition was medium; and when the lithium deposition area on the surface of the negative electrode plate accounted for more than 20% of the total area of the negative electrode plate, the degree of lithium deposition was high.

TABLE 10

| | Negative | Silicon | | Energy | Capacity | Degree of |
|---|---|---|---|---|---|---|
| | electrode | oxide | Mass | density | retention | lithium |
| | plate | particles | proportion | (Wh/L) | rate | deposition |
| Example III4 | Example III1 | Example 1 | 16% | 632 | 82% | Low |
| Example III5 | Example III2 | Example 2 | 16% | 641 | 83% | Low |
| Example III6 | Example III3 | Example 3 | 16% | 628 | 82% | Low |
| Comparative | Comparative | Comparative | 16% | 579 | 72% | Medium |
| Example III12 | Example III1 | Example 1 | | | | |
| Comparative | Comparative | Comparative | 16% | 650 | 54% | High |
| Example III13 | Example III2 | Example 2 | | | | |
| Comparative | Comparative | Comparative | 16% | 626 | 73% | High |
| Example III14 | Example III3 | Example 3 | | | | |
| Comparative | Comparative | Comparative | 16% | 629 | 65% | High |
| Example III15 | Example III4 | Example 4 | | | | |
| Comparative | Comparative | Comparative | 16% | 631 | 61% | High |
| Example III16 | Example III5 | Example 5 | | | | |
| Comparative | Comparative | Comparative | 16% | 628 | 72% | Medium |
| Example III17 | Example III6 | Example 6 | | | | |
| Comparative | Comparative | Example 1 | 3.2% | 553 | 71% | High |
| Example III18 | Example III7 | | | | | |
| Comparative | Comparative | Example 1 | 32% | 662 | 73% | Medium |
| Example III19 | Example III8 | | | | | |
| Comparative | Comparative | Example 1 | 16% | 611 | 76% | High |
| Example III20 | Example III9 | | | | | |
| Comparative | Comparative | Example 1 | 16% | 625 | 74% | Medium |
| Example III21 | Example III10 | | | | | |
| Comparative | Comparative | Example 1 | 10% | 588 | 69% | High |
| Example III22 | Example III11 | | | | | |

It may be learned from Table 10 that: the negative electrode plates in Examples III1 to III3 and the lithium-ion batteries in corresponding Examples III4 to III6 met characteristics described in the present disclosure, that is, energy density of a battery was greater than 600 Wh/L, a cycling capacity retention rate was greater than 80%, and a degree of lithium deposition was low; for the negative electrode plate in Comparative Example III1 and the lithium-ion battery in Comparative Example III12, a molar ratio of O/Si of silicon oxide particles used was too high, energy density of the battery was less than 600 Wh/L, a cycling capacity retention rate was less than 80%, and a degree of lithium deposition was medium; for the negative electrode plate in Comparative Example III2 and the lithium-ion battery in Comparative Example III13, a molar ratio of O/Si of silicon oxide particles used was too low, a cycling capacity retention rate was less than 80%, and a degree of lithium deposition was high; none of Dᵢ, dᵢ, (ΣEⱼ²)/(ΣDᵢ²), and (ΣFₖ²)/(ΣDᵢ²) of the negative electrode plate in Comparative Example III3 and Dᵢ′, dᵢ′, (ΣEⱼ′²)/(ΣDᵢ′²), and (ΣFₖ′²)/(ΣDᵢ′²) of the lithium-ion battery in Comparative Example III14 met requirements of the present disclosure, a cycling capacity retention rate was less than 80%, and a degree of lithium deposition was high; none of (ΣEⱼ²)/(ΣDᵢ²) and (ΣFₖ²)/(ΣDᵢ²) of the negative electrode plate in Comparative Example III4 and (ΣEⱼ′²)/(ΣDᵢ′²) and (ΣFₖ′²)/(ΣDᵢ′²) of the lithium-ion battery in Comparative Example III15 met requirements of the present disclosure, a cycling capacity retention rate was less than 80%, and a degree of lithium deposition was high; none of (ΣEⱼ²)/(ΣDᵢ²), (ΣFₖ²)/(ΣDᵢ²), and (ΣFₖ²)/S of the negative electrode plate in Comparative Example III5 and (ΣEⱼ′2)/(ΣDᵢ′²), (ΣEₖ′²)/(ΣDᵢ′²), and (ΣFₖ′²)/S of the lithium-ion battery in Comparative Example III16 met requirements of the present disclosure, a cycling capacity retention rate was less than 80%, and a degree of lithium deposition was high; neither of (ΣFₖ²)/(ΣDᵢ²) of the negative electrode plate in Comparative Example III6 and (ΣFₖ′²)/(ΣDᵢ′²) of the lithium-ion battery in Comparative Example III17 met requirements of the present disclosure, a cycling capacity retention rate was less than 80%, and a degree of lithium deposition was medium; neither of (ΣFₖ²)/S of the negative electrode plate in Comparative Example III7 and (ΣFₖ′²)/S of the lithium-ion battery in Comparative Example III18 met requirements of the present disclosure, a cycling capacity retention rate was less than 80%, and a degree of lithium deposition was high; neither of (ΣFₖ²)/S of the negative electrode plate in Comparative Example III8 and (ΣFₖ′²)/S of the lithium-ion battery in Comparative Example III19 met requirements of the present disclosure, a cycling capacity retention rate was less than 80%, and a degree of lithium deposition was medium; neither of L_{A} of the negative electrode plate in Comparative Example III9 and L_{A}′ of the lithium-ion battery in Comparative Example III20 met requirements of the present disclosure, an initial constant-current charging ratio was less than 60%, a cycling capacity retention rate was less than 80%, and a degree of lithium deposition was high; neither of L_{B} of the negative electrode plate in Comparative Example III10 and L_{B}′ of the lithium-ion battery in Comparative Example III21 met requirements of the present disclosure, a cycling capacity retention rate was less than 80%, and a degree of lithium deposition was medium; and silicon oxide particles of the negative electrode plate were uniformly distributed in the active material layer in Comparative Example III11 and Comparative Example III22, which did not meet requirements of the present disclosure, a cycling capacity retention rate was less than 80%, and a degree of lithium deposition was high.

The implementations of the present disclosure are described above. However, the present disclosure is not limited to the foregoing implementations. Any modifications, equivalent replacements, improvements, and the like within the spirit and principle of the present disclosure shall fall within the scope of protection of the present disclosure.

What is claimed is:

1. A negative electrode plate, comprising a negative electrode current collector and a negative electrode active material layer, wherein the negative electrode active material layer is disposed on at least one surface of the negative electrode current collector, the negative electrode active material layer comprises silicon-based material particles, and the silicon-based material particles comprise silicon oxide and/or silicon carbide; and
the silicon-based material particles meet the following relationship:
$${D}_{i} \leq 35 µm , \qquad ( I )$$
$${d}_{i} \leq 25 µm , \qquad ( II )$$
$$0.45 \leq ( \sum {E}_{j}^{2} ) / ( \sum {D}_{i}^{2} ) \leq 0 \text{.75} , \qquad ( III )$$
$$and$$
$$( \sum {F}_{k}^{2} ) / ( \sum {D}_{i}^{2} ) \geq 0 \text{.37} , \qquad ( IV )$$
wherein Σ represents performing summation on data, Dᵢ represents a diameter of a circumscribed circle of any silicon-based material particle, in a unit of μm, dᵢ represents a diameter of an inscribed circle of any silicon-based material particle, in a unit of μm, Eⱼ represents a diameter of a circumscribed circle of a silicon-based material particle having Dᵢ≥9 μm, in a unit of μm, Fₖ represents a diameter of a circumscribed circle of a silicon-based material particle having dᵢ≥4 μm, in a unit of μm, and i, j, and k represent numbers of silicon-based material particles.

2. The negative electrode plate according to claim 1, wherein in the negative electrode plate, a mixing amount of the silicon-based material particles meets the following relationship:
$$0.05 \leq ( \sum {F}_{k}^{2} ) / S \leq 0 \text{.47} , \qquad ( V )$$
wherein Σ represents performing summation on data, Fₖ represents a diameter of a circumscribed circle of a silicon-based material particle having dᵢ≥4 μm, in a unit of μm, k represents a number of a silicon-based material particle, and S represents a cross-sectional area of an active material layer in an observation region, in a unit of μm².

3. The negative electrode plate according to claim 1, wherein a mass concentration of the silicon-based material particles ranges from 5 wt % to 25 wt % in the negative electrode active material layer.

4. The negative electrode plate according to claim 1, wherein a thickness L of the negative electrode active material layer in the negative electrode plate meets 30 μm≤L≤100 μm.

5. The negative electrode plate according to claim 1, wherein at least some surfaces of the silicon-based material particles contain coating layers.

6. The negative electrode plate according to claim 5, wherein the coating layer is a carbon coating layer, and a material of the carbon coating layer is selected from one or more of graphite, amorphous carbon, graphene, or a carbon nanotube.

7. The negative electrode plate according to claim 1, wherein a specific surface area of the silicon-based material particles is less than or equal to 1.2 m²/g.

8. The negative electrode plate according to claim 1, wherein the silicon-based material particles comprise at least the following characteristics:
$${D}_{v} max \leq 35 , \qquad ( VI )$$
$$9. \leq {D}_{v} 50 \leq 13. , \qquad ( VII )$$
$$and$$
$$BET \leq 1.2 , \qquad ( VIII )$$
wherein Dᵥmax represents a maximum particle size of the silicon-based material particles, in a unit of μm;
Dᵥ50 represents a median particle size of the silicon-based material particles, in a unit of μm; and
BET represents a specific surface area of the silicon-based material particles, in a unit of m²/g.

9. The negative electrode plate according to claim 1, wherein the silicon-based material particles are silicon oxide particles, and the silicon oxide particles comprise an element Si and an element O, a molar ratio x (mol/mol) of the element O to the element Si meets 0.7≤x≤1.4.

10. The negative electrode plate according to claim 1, wherein the negative electrode active material layer comprises an active material layer A and an active material layer B, and the active material layer A is disposed between the current collector and the active material layer B.

11. The negative electrode plate according to claim 10, wherein
the active material layer A contains the silicon-based material particles and has a thickness L_{A} meeting 35 μm≤L_{A}≤60 μm; and
the active material layer B does not contain the silicon-based material particles and has a thickness L_{B} meeting 20 μm≤L_{B}≤50 μm.

12. The negative electrode plate according to claim 11, wherein using a total weight of the active material layer A as a reference, a mass proportion of the silicon-based material particles ranges from 5 wt % to 25 wt %.

13. The negative electrode plate according to claim 10, wherein
the active material layer A does not contain the silicon-based material particles and has a thickness L_{A} meeting 20 μm≤L_{A}≤40 μm; and
the active material layer B contains the silicon-based material particles and has a thickness L_{B} meeting 35 μm≤ L_{B}≤60 μm.

14. The negative electrode plate according to claim 13, wherein using a total weight of the active material layer B as a reference, a mass proportion of the silicon-based material particles ranges from 5 wt % to 25 wt %.

15. The negative electrode plate according to claim 10, wherein using a total weight of the negative electrode active material layer as a reference, a weight content of another negative electrode material ranges from 92 wt % to 99 wt %, a weight content of a conductive agent ranges from 0.5 wt % to 4 wt %, and a weight content of a binder ranges from 0.5 wt % to 4 wt %.

16. A lithium-ion battery, comprising the negative electrode plate according to claim 1.

17. The lithium-ion battery according to claim 16, wherein after one to five charge-discharge cycles are performed for the lithium-ion battery, the negative electrode plate meets the following relationship:
$${D}_{i}^{′} \leq 44 µm , \qquad ( IX )$$
$${d}_{i}^{′} \leq 32 µm , \qquad ( X )$$
$$045 \leq ( \sum {E}_{j}^{′2} ) / ( \sum {D}_{i}^{′2} ) \leq 0 \text{.75} , \qquad ( XI )$$
$$( \sum {F}_{k}^{′2} ) / ( \sum {D}_{i}^{′2} ) \geq 0 \text{.37} , \qquad ( XII )$$
$$0.06 \leq ( \sum {F}_{k}^{′2} ) / {S}^{′} \leq 0.53 , \qquad ( XIII )$$
$$and$$
$$39 µm \leq {L}^{′} \leq 130 µm , \qquad ( XIV )$$
wherein Σ represents performing summation on data, Dᵢ′ represents a diameter of a circumscribed circle of any silicon-based material particle, in a unit of μm, dᵢ′ represents a diameter of an inscribed circle of any silicon-based material particle, in a unit of μm, Eⱼ′ represents a diameter of a circumscribed circle of a silicon-based material particle having Dᵢ′≥11.2 μm, in a unit of μm, Fₖ′ represents a diameter of a circumscribed circle of a silicon-based material particle having dᵢ′≥5.0 μm, in a unit of μm, i, j, and k represent numbers of silicon-based material particles, S′ represents a cross-sectional area of the negative electrode plate in an observation region, in a unit of μm², and L′ represents a thickness of an active material layer, in a unit of μm.

18. The lithium-ion battery according to claim 17, wherein an active material layer A close to a negative electrode current collector contains silicon-based material particles, and an active material layer B away from the negative electrode current collector does not contain silicon-based material particles; and
after the one to five charge-discharge cycles are performed for the lithium-ion battery, a thickness L_{A}′ of the active material layer A meets 44 μm≤L_{A}′≤75 μm, and a thickness L_{B}′ of the active material layer B meets 21 μm≤L_{B}′≤55 μm.

19. The lithium-ion battery according to claim 17, wherein an active material layer A close to a negative electrode current collector does not contain silicon-based material particles, and an active material layer B away from the negative electrode current collector contains silicon-based material particles; and
after the one to five charge-discharge cycles are performed for the lithium-ion battery, the negative electrode plate meets the following relationship: a thickness L_{A}′ of the active material layer A meets 21 μm≤L_{A}′≤44 μm, and a thickness L_{B}′ of the active material layer B meets 44 μm≤L_{B}′≤75 μm.
